(19) United States
(12) Patent Application Publication
(10) Pub. No.: US 2026/0251940 A1
(43) Pub. Date: Aug. 27, 2026

(54) LIQUID CRYSTAL DISPLAY SUBSTRATE AND METHOD OF MANUFACTURING THE SAME, AND DISPLAY DEVICE

(71) Applicant: BOE Technology Group Co., Ltd., Beijing (CN)

(72) Inventors: Wenqu LIU, Beijing (CN); Tengfei LIU, Beijing (CN); Feng ZHANG, Beijing (CN)

(21) Appl. No.: 18/856,606

(22) PCT Filed: Sep. 13, 2023
(86) PCT No.: PCT/CN2023/118515

§ 371 Date: Oct. 11, 2024

(51) Int. Cl. G02F 1/1362; G02F 1/1368

(52) U.S. Cl. CPC G02F 1/136227; G02F 1/136209; G02F 1/136222; G02F 1/1368

(57) ABSTRACT

Provided are a liquid crystal display substrate and a method of manufacturing the same, and a display device. The liquid crystal display substrate includes: a base substrate; a first semiconductor layer; a first gate layer; a first conductive layer; a second conductive layer connected to an active layer of a first thin film transistor through a second via hole to form a second electrode of the first thin film transistor; a planarization layer; a third conductive layer; a passivation layer; a fourth conductive layer; a liquid crystal layer; and a black matrix layer, including a black matrix region and a black matrix opening region. The second conductive layer, the third conductive layer and the fourth conductive layer include a transparent conductive material, and an orthographic projection of the second via hole on the base substrate falls within an orthographic projection of the black matrix opening region on the base substrate.

### CROSS-REFERENCE TO RELATED APPLICATION(S)

This application is a Section 371 National Stage Application of International Application No. PCT/CN2023/118515, filed on Sep. 13, 2023, the disclosure of which is hereby incorporated in its entirety by reference.

### TECHNICAL FIELD

The present disclosure relates to the field of display technology, and in particular to a liquid crystal display substrate and a method of manufacturing the same, and a display device.

### BACKGROUND

With a diversified development in the fields of VR (virtual reality) and AR (augmented reality) applications, a demand for VR and AR products is growing rapidly. A display panel is one of core hardware of VR and AR products, in which more pixel viewpoints are required to restore a real scene, and a demand for PPI (Pixels Per Inch) is increasingly higher. In general, a resolution is required to be higher than 1500 PPI. The higher the PPI of the display panel, the smaller the area occupied by a single pixel. As a pixel size decreases, an opening ratio may decrease sharply, and then a display brightness may decrease, which may seriously reduce the applications of the display panel in the fields of VR and AR.

The above information disclosed in this section is just for understanding of the background of the present disclosure. Therefore, the above information may include information that does not constitute the related art.

### SUMMARY

In an aspect, a liquid crystal display substrate is provided, including a plurality of pixel units provided in a display region of the liquid crystal display substrate, the pixel unit includes a first thin film transistor. The liquid crystal display substrate includes: a base substrate; a first semiconductor layer provided on a side of the base substrate, an active layer of the first thin film transistor is located in the first semiconductor layer; a first gate layer provided on a side of the first semiconductor layer away from the base substrate, a gate electrode of the first thin film transistor is located in the first gate layer; a first conductive layer provided on a side of the first gate layer away from the base substrate, the first conductive layer is electrically connected to the active layer of the first thin film transistor through a first via hole so as to form a first electrode of the first thin film transistor; a second conductive layer provided on a side of the first conductive layer away from the base substrate, the second conductive layer is electrically connected to the active layer of the first thin film transistor through a second via hole so as to form a second electrode of the first thin film transistor; a planarization layer provided on a side of the second conductive layer away from the base substrate, a part of the planarization layer fills the second via hole; a third conductive layer provided on a side of the planarization layer away from the base substrate, the third conductive layer is electrically connected to the second conductive layer through a third via hole, and a pixel electrode of the pixel unit is located in the third conductive layer; a passivation layer provided on a side of the third conductive layer away from the base substrate; a fourth conductive layer provided on a side of the passivation layer away from the base substrate, a common electrode of the plurality of pixel units is located in the fourth conductive layer; a liquid crystal layer provided on a side of the fourth conductive layer away from the base substrate, the liquid crystal layer is located in the display region; and a black matrix layer provided on a side of the liquid crystal layer away from the base substrate, the black matrix layer is located in the display region, and the black matrix layer includes a black matrix region and a black matrix opening region. The second conductive layer, the third conductive layer and the fourth conductive layer include a transparent conductive material, and an orthographic projection of the second via hole on the base substrate falls within an orthographic projection of the black matrix opening region on the base substrate.

In some exemplary embodiments of the present disclosure, the second via hole includes a first end away from the base substrate and a second end close to the base substrate, and a via hole opening area of the second via hole parallel to an upper surface of the base substrate gradually decreases from the first end to the second end.

In some exemplary embodiments of the present disclosure, a sidewall section line of the second via hole has a first angle θ1 with the upper surface of the base substrate, 45°<θ1<90°; and the sidewall section line of the second via hole is obtained by intersecting a sidewall of the second via hole and a section where a symmetry axis of the second via hole is located.

In some exemplary embodiments of the present disclosure, a slope change rate of the sidewall section line close to the first end is greater than a slope change rate of the sidewall section line close to the second end.

In some exemplary embodiments of the present disclosure, the first end of the second via hole has a via hole width a, and the second end of the second via hole has a via hole width b, and 2.5 μm≤a≤4.5 μm, 1.5 μm≤b≤3.5 μm.

In some exemplary embodiments of the present disclosure, the planarization layer includes a first planarization region and a second planarization region, an orthographic projection of the first planarization region on the base substrate falls within the orthographic projection of the second via hole on the base substrate, and the second planarization region is a region outside the first planarization region; and
the first planarization region includes a first planarization surface away from the second conductive layer, the second planarization region includes a second planarization surface away from the second conductive layer, and a segment difference between the first planarization surface and the second planarization surface is less than 0.2 μm.

In some exemplary embodiments of the present disclosure, in a direction perpendicular to the upper surface of the base substrate, a depth H1 of the second via hole and a thickness H2 of the planarization layer meet a linear relationship of:

$${H}_{1} = A \times {H}_{2} + 0.2 , where 0.4 \leq A \leq 0.6 .$$

In some exemplary embodiments of the present disclosure, the liquid crystal display substrate further includes: a supporting material layer provided between the passivation layer and the black matrix layer to separate the pixel unit into a plurality of sub-pixels, an orthographic projection of the supporting material layer on the base substrate falls within an orthographic projection of the black matrix region on the base substrate.

In some exemplary embodiments of the present disclosure, the liquid crystal display substrate further includes: a light shielding layer provided between the supporting material layer and the passivation layer, an orthographic projection of the light shielding layer on the base substrate falls within the orthographic projection of the black matrix region on the base substrate.

In some exemplary embodiments of the present disclosure, an orthographic projection of the third via hole on the base substrate falls within the orthographic projection of the black matrix opening region on the base substrate.

In some exemplary embodiments of the present disclosure, an orthographic projection of the third via hole on the base substrate falls within the orthographic projection of the black matrix region on the base substrate.

In some exemplary embodiments of the present disclosure, the planarization layer includes a first planarization sub-portion and a second planarization sub-portion, a part of the second conductive layer and a part of the first planarization sub-portion fill the second via hole; a part of the third conductive layer and the second planarization sub-portion fill the third via hole, and an orthographic projection of the second planarization sub-portion on the base substrate falls within the orthographic projection of the third via hole on the base substrate.

In some exemplary embodiments of the present disclosure, the planarization layer includes a first planarization layer close to the second conductive layer and a second planarization layer away from the second conductive layer; the second via hole penetrates the first planarization layer and exposes the active layer of the first thin film transistor, and a part of the second conductive layer and a part of the planarization layer fill the second via hole; and the third via hole penetrates the second planarization layer and exposes the second conductive layer, and a part of the passivation layer and a part of the supporting material layer fill the third via hole.

In some exemplary embodiments of the present disclosure, the liquid crystal display substrate further includes: an interlayer insulation layer provided between the first semiconductor layer and the planarization layer. The second via hole includes a first via sub-hole and a second via sub-hole; the second conductive layer includes a first conductive sub-layer close to the base substrate and a second conductive sub-layer away from the base substrate; the first via sub-hole penetrates the interlayer insulation layer and exposes the active layer of the first thin film transistor, and a part of the first conductive sub-layer and a part of the first planarization layer fill the first via sub-hole; and the second via sub-hole penetrates the first planarization layer and exposes the first conductive sub-layer, and a part of the second conductive sub-layer and a part of the second planarization layer fill the second via sub-hole.

In some exemplary embodiments of the present disclosure, the supporting material layer includes a first supporting material layer close to the passivation layer and a second supporting material layer away from the passivation layer, the orthographic projection of the third via hole on the base substrate falls within an orthographic projection of the first supporting material layer on the base substrate, and a part of the first supporting material layer fills the third via hole.

In some exemplary embodiments of the present disclosure, the liquid crystal display substrate further includes: a color filter layer provided in a same layer as the planarization layer, an orthographic projection of the color filter layer on the base substrate falls within the orthographic projection of the black matrix opening region on the base substrate.

In some exemplary embodiments of the present disclosure, a thickness H₃ of the color filter layer, a thickness H₂₁ of the first planarization layer and a thickness H₂₂ of the second planarization layer meet a relationship of:

$${H}_{21} + {H}_{22} > {H}_{3} .$$

In some exemplary embodiments of the present disclosure, the liquid crystal display substrate further includes: a color filter layer provided in a same layer as the black matrix layer, an orthographic projection of the color filter layer on the base substrate falls within the orthographic projection of the black matrix opening region on the base substrate.

In some exemplary embodiments of the present disclosure, an orthographic projection of the first thin film transistor on the base substrate overlaps with the orthographic projection of the black matrix opening region on the substrate; the first gate layer includes a first gate sub-layer and a second gate sub-layer; and at least one of the first gate sub-layer and the second gate sub-layer includes a transparent conductive material.

In some exemplary embodiments of the present disclosure, the third via hole has a same shape as the second via hole, and the planarization layer includes an organic transparent material.

In some exemplary embodiments of the present disclosure, the plurality of pixel units include a first group of pixel units arranged in a first direction and a second group of pixel units arranged in the first direction, and the first group of pixel units is adjacent to the second group of pixel units in a second direction perpendicular to the first direction; sub-pixels in the first group of pixel units are staggered with sub-pixels in the second group of pixel units in the second direction; or the sub-pixels in the first group of pixel units are aligned with the sub-pixels in the second group of pixel units in the second direction.

In another aspect, a method of manufacturing a liquid crystal display substrate is provided, the liquid crystal display substrate includes a plurality of pixel units provided in a display region, the pixel unit includes a first thin film transistor, and the method of manufacturing the liquid crystal display substrate includes:
providing a base substrate;
forming a first semiconductor layer on a side of the base substrate, an active layer of the first thin film transistor is located in the first semiconductor layer;
forming a first gate layer on a side of the first semiconductor layer away from the base substrate, a gate electrode of the first thin film transistor is located in the first gate layer;
forming a first conductive layer on a side of the first gate layer away from the base substrate, the first conductive layer is electrically connected to the active layer of the first thin film transistor through a first via hole so as to form a first electrode of the first thin film transistor;
forming a second via hole to expose the active layer of the first thin film transistor;
forming a second conductive layer on a side of the first conductive layer away from the base substrate, the second conductive layer is electrically connected to the active layer of the first thin film transistor through a second via hole so as to form a second electrode of the first thin film transistor;
forming a planarization layer on a side of the second conductive layer away from the base substrate, a part of the planarization layer fills the second via hole;
forming a third conductive layer on a side of the planarization layer away from the base substrate, the third conductive layer is electrically connected to the second conductive layer through a third via hole, and a pixel electrode of the pixel unit is located in the third conductive layer;
forming a passivation layer on a side of the third conductive layer away from the base substrate;
forming a fourth conductive layer on a side of the passivation layer away from the base substrate, a common electrode of the plurality of pixel units is located in the fourth conductive layer;
forming a liquid crystal layer on a side of the fourth conductive layer away from the base substrate, the liquid crystal layer is located in the display region; and
forming a black matrix layer on a side of the liquid crystal layer away from the base substrate, the black matrix layer is located in the display region, and the black matrix layer includes a black matrix region and a black matrix opening region,
the second conductive layer, the third conductive layer and the fourth conductive layer include a transparent conductive material, and an orthographic projection of the second via hole on the base substrate falls within an orthographic projection of the black matrix opening region on the base substrate.

In some exemplary embodiments of the present disclosure, the forming the second via hole to expose the active layer of the first thin film transistor includes: etching an insulation layer on a side of the first conductive layer away from the base substrate to form the second via hole so as to expose the active layer of the first thin film transistor;
the second via hole includes a first end away from the base substrate and a second end close to the base substrate, and a via hole opening area of the second via hole parallel to an upper surface of the base substrate gradually decreases from the first end to the second end;
a sidewall section line of the second via hole has a first angle θ1 with the upper surface of the base substrate;

$$45 ° < ⊖ 1 < 90 ° ;$$

the sidewall section line of the second via hole is obtained by intersecting a sidewall of the second via hole and a section a symmetry axis of the second via hole is located;
a slope change rate of the sidewall section line close to the first end is greater than a slope change rate of the sidewall section line close to the second end;
the first end of the second via hole has a via width a, and the second end of the second via hole has a via width b, 2.5 μm≤a≤4.5 μm, 1.5 μm≤b≤3.5 μm.

In some exemplary embodiments of the present disclosure, the forming the planarization layer on a side of the second conductive layer away from the base substrate includes: drying and curing the planarization layer, a heating rate of the drying and curing is in a range of 5° C./min to 15° C./min.

In another aspect, a display device is provided, including the liquid crystal display substrate described above.

### BRIEF DESCRIPTION OF THE DRAWINGS

By describing in detail exemplary embodiments of the present disclosure with reference to the accompanying drawings, features and advantages of the present disclosure will become more apparent. In the accompanying drawings:

FIG. 1A shows a schematic diagram of a planar structure of a liquid crystal display substrate according to an exemplary embodiment of the present disclosure;

FIG. 1B shows a schematic diagram of a planar structure of a liquid crystal display substrate according to another exemplary embodiment of the present disclosure;

FIG. 2A shows a schematic diagram of a planar structure of a sub-pixel of the liquid crystal display substrate according to an exemplary embodiment of FIG. 1A;

FIG. 2B shows a schematic diagram of a planar structure of a sub-pixel of the liquid crystal display substrate according to another exemplary embodiment of FIG. 1A;

FIG. 2C shows a schematic diagram of a planar structure of a sub-pixel arrangement in the liquid crystal display substrate according to an exemplary embodiment of FIG. 1B;

FIG. 3A shows a schematic diagram of a cross-sectional structure of the liquid crystal display substrate according to the exemplary embodiment of FIG. 2C taken along line A-A′;

FIG. 3B shows a schematic diagram of a cross-sectional structure at a second via hole of a liquid crystal display substrate according to an exemplary embodiment of the present disclosure;

FIG. 3C shows a schematic diagram of a cross-sectional structure at a second via hole of a planarization layer of a liquid crystal display substrate according to an exemplary embodiment of the present disclosure;

FIG. 3D shows a morphology diagram of a cross-sectional structure at a second via hole of a planarization layer of a liquid crystal display substrate according to an exemplary embodiment of the present disclosure;

FIG. 3E shows a morphology diagram of a cross-sectional structure at a third via hole of a liquid crystal display substrate according to an exemplary embodiment of the present disclosure;

FIG. 3F shows a morphology diagram of a cross-sectional structure at a third via hole of a liquid crystal display substrate according to another exemplary embodiment of the present disclosure;

FIG. 3G shows a schematic diagram of a cross-sectional structure of the liquid crystal display substrate according to the exemplary embodiment of FIG. 2C taken along line B-B′;

FIG. 4A shows a schematic diagram of a cross-sectional structure of a liquid crystal display substrate 200 according to another exemplary embodiment of the present disclosure;

FIG. 4B shows a schematic diagram of a cross-sectional structure of a liquid crystal display substrate 200′ including a light shielding layer according to another exemplary embodiment of the present disclosure;

FIG. 4C shows a schematic diagram of a cross-sectional structure of a liquid crystal display substrate 300 according to another exemplary embodiment of the present disclosure;

FIG. 4D shows a schematic diagram of a cross-sectional structure of a liquid crystal display substrate 300′ including a light shielding layer according to another exemplary embodiment of the present disclosure;

FIG. 5A shows a schematic diagram of a cross-sectional structure of a liquid crystal display substrate 400 according to another exemplary embodiment of the present disclosure;

FIG. 5B shows a schematic diagram of a cross-sectional structure of a liquid crystal display substrate 400′ including a light shielding layer according to another exemplary embodiment of the present disclosure;

FIG. 5C shows a schematic diagram of a cross-sectional structure of a liquid crystal display substrate 500 according to another exemplary embodiment of the present disclosure;

FIG. 5D shows a schematic diagram of a cross-sectional structure of a liquid crystal display substrate 500′ including a light shielding layer according to another exemplary embodiment of the present disclosure;

FIG. 6A shows a morphology diagram of a cross-sectional structure at a second via hole of a liquid crystal display substrate according to an exemplary embodiment of the present disclosure;

FIG. 6B shows a morphology diagram of a cross-sectional structure at a second via hole of a liquid crystal display substrate according to another exemplary embodiment of the present disclosure;

FIG. 6C shows a morphology diagram of a cross-sectional structure at a third via hole of a first supporting material layer of a liquid crystal display substrate according to an exemplary embodiment of the present disclosure;

FIG. 7A to FIG. 7F show flowcharts of a manufacturing process of a second via hole of a liquid crystal display substrate according to an exemplary embodiment of the present disclosure;

FIG. 8A to FIG. 8B show flowcharts of a planarization process of a second via hole of a liquid crystal display substrate according to an exemplary embodiment of the present disclosure;

FIG. 9A to FIG. 9C show flowcharts of a planarization process of a third via hole of a liquid crystal display substrate according to an exemplary embodiment of the present disclosure;

FIG. 10A shows a schematic structural diagram of a display device according to an exemplary embodiment of the present disclosure; and

FIG. 10B shows a schematic structural diagram of a display device according to another exemplary embodiment of the present disclosure.

It should be noted that for the sake of clarity, in the accompanying drawings used to describe the embodiments of the present disclosure, sizes of layers, structures or regions may be enlarged or reduced, that is, these accompanying drawings are not drawn according to actual scale.

### DETAILED DESCRIPTION OF THE EMBODIMENTS

In order to make objectives, technical solutions and advantages of the embodiments of the present disclosure clearer, technical solutions of the embodiments of the present disclosure will be clearly and completely described below with reference to the accompanying drawings. Obviously, the described embodiments are just some embodiments rather than all embodiments of the present disclosure. Based on the described embodiments of the present disclosure, all additional embodiments obtained by those ordinary skilled in the art without carrying out inventive effort fall within the scope of protection of the present disclosure.

It should be noted that in the accompanying drawings, for clarity and/or description purposes, a size and relative size of an element may be enlarged. Accordingly, the size and relative size of each element need not to be limited to those shown in the drawings. In the specification and the accompanying drawings, the same or similar reference numerals represent the same or similar components.

When an element is described as being “on”, “connected to” or “coupled to” another element, the element may be directly on the another element, directly connected to the another element, or directly coupled to the another element, or an intermediate element may be provided. However, when an element is described as being “directly on”, “directly connected to” or “directly coupled to” another element, no intermediate element is provided. Other terms and/or expressions used to describe a relationship between elements, such as “between” and “directly between”, “adjacent to” and “directly adjacent to”, “on” and “directly on”, and so on, should be interpreted in a similar manner. In addition, the term “connection” may refer to a physical connection, an electrical connection, a communicative connection, and/or a fluid connection. In addition, X-axis, Y-axis and Z-axis are not limited to three axes of a rectangular coordinate system, and may be interpreted in a broader meaning. For example, the X-axis, the Y-axis and the Z-axis may be perpendicular to each other, or may represent different directions that are not perpendicular to each other. For objectives of the present disclosure, “at least one selected from X, Y or Z” and “at least one selected from a group consisting of X, Y and Z” may be interpreted as only X, only Y, only Z, or any combination of two or more of X, Y and Z, such as XYZ, XYY, YZ and ZZ. As used herein, the term “and/or” includes any and all combinations of one or more of the listed related items.

It should be noted that although the terms “first”, “second”, and so on may be used here to describe various components, members, elements, regions, layers and/or portions, these components, members, elements, regions, layers and/or portions should not be limited by these terms. Rather, these terms are used to distinguish one component, member, element, region, layer and/or portion from another one. Thus, for example, a first component, a first member, a first element, a first region, a first layer and/or a first portion discussed below may be referred to as a second component, a second member, a second element, a second region, a second layer and/or a second portion without departing from teachings of the present disclosure.

For ease of description, spatial relationship terms, such as “upper”, “lower”, “left”, “right”, may be used herein to describe a relationship between an element or feature and another element or feature as shown in the drawings. It should be understood that the spatial relationship terms are intended to cover other different orientations of a device in use or operation in addition to the orientation described in the drawings. For example, if a device in the drawings is turned upside down, an element or feature described as “below” or “under” another element or feature will be oriented “above” or “on” the another element or feature.

It should be noted that the expression “the same layer” herein refers to a layer structure that is formed by firstly forming, using a same film forming process, a film layer used to form a specific pattern, and then patterning, using one-time patterning process, the film layer with a same mask. Depending on different specific patterns, the one-time patterning process may include a plurality of exposure, development or etching processes, and the specific pattern in the formed layer structure may be continuous or discontinuous. That is, a plurality of elements, components, structures and/or portions located in the “same layer” are made of the same material and formed by the same patterning process. Generally, a plurality of elements, components, structures and/or portions located in the “same layer” have substantially the same thickness.

Those skilled in the art should understand that, unless otherwise specified, the expression “height” or “thickness” herein refers to a size in a direction perpendicular to a surface of each film layer provided on the display substrate, that is, a size in a light emitting direction of the display substrate, or referred to as a size in a normal direction of the display device.

Herein, the directional expressions “first direction” and “second direction” are used to describe different directions along a pixel region, e.g., a longitudinal direction and a transverse direction of the pixel region, or a row direction and a column direction of an arrangement of sub-pixels. It should be understood that such expressions are just exemplary descriptions and not limitations to the present disclosure.

In an existing liquid crystal display device, an existing liquid crystal display substrate includes a pixel electrode, a common electrode, a wire region and a via hole region. The wire region and the via hole region are shielded by a black matrix in a black matrix layer, so as to avoid light leakage and other problems. As PPI increases and a pixel size decreases, a pixel opening ratio may decrease sharply, resulting in a decrease in display brightness, which is not conducive to a design of high-PPI display panel. In the existing liquid crystal display substrate, the via hole region is shielded by the black matrix, and an improvement of the pixel opening ratio of the liquid crystal display substrate is generally achieved by reducing a wire size. However, the wire size is limited by processes. In addition, a reduction of the wire size may cause an increase of resistance, and a voltage may decrease significantly at different positions of the display substrate, which may result in a decrease in display uniformity of the display substrate and other problems.

In order to solve the problems of the low opening ratio and the low display brightness in case of high PPI in the liquid crystal display substrate in the related art, the present disclosure provides a liquid crystal display substrate having a plurality of pixel units provided in a display region of the liquid crystal display substrate, where the pixel unit includes a first thin film transistor. The liquid crystal display substrate may include but not be limited to: a base substrate; a first semiconductor layer provided on a side of the base substrate, where an active layer of the first thin film transistor is located in the first semiconductor layer; a first gate layer provided on a side of the first semiconductor layer away from the base substrate, where a gate electrode of the first thin film transistor is located in the first gate layer; a first conductive layer provided on a side of the first gate layer away from the base substrate, where the first conductive layer is electrically connected to the active layer of the first thin film transistor through a first via hole to form a first electrode of the first thin film transistor; a second conductive layer provided on a side of the first conductive layer away from the base substrate, where the second conductive layer is electrically connected to the active layer of the first thin film transistor through a second via hole to form a second electrode of the first thin film transistor; a planarization layer provided on a side of the second conductive layer away from the base substrate, where a part of the planarization layer fills the second via hole; a third conductive layer provided on a side of the planarization layer away from the base substrate, where the third conductive layer is electrically connected to the second conductive layer through a third via hole, and a pixel electrode of the pixel unit is located in the third conductive layer; a passivation layer provided on a side of the third conductive layer away from the base substrate; a fourth conductive layer provided on a side of the passivation layer away from the base substrate, where a common electrode of the plurality of pixel units is located in the fourth conductive layer; a liquid crystal layer provided on a side of the fourth conductive layer away from the base substrate, where the liquid crystal layer is located in the display region; and a black matrix layer provided on a side of the liquid crystal layer away from the base substrate, where the black matrix layer is located in the display region, and the black matrix layer includes a black matrix region and a black matrix opening region. The second conductive layer, the third conductive layer and the fourth conductive layer include a transparent conductive material, and an orthographic projection of the second via hole on the base substrate falls within an orthographic projection of the black matrix opening region on the base substrate.

In the liquid crystal display substrate according to the embodiments of the present disclosure, the second conductive layer, the third conductive layer and the fourth conductive layer are made of a transparent conductive material, and the orthographic projection of the second via hole on the base substrate falls within the orthographic projection of the black matrix opening region on the base substrate, so that the second via hole connecting the first thin film transistor and the pixel electrode is located in the display region and the second via hole is not shielded by the black matrix. In a case of a same wire size preparation process, the pixel opening ratio of the liquid crystal display substrate may be effectively improved to meet the requirements for high PPI without reducing a display effect of the liquid crystal display substrate.

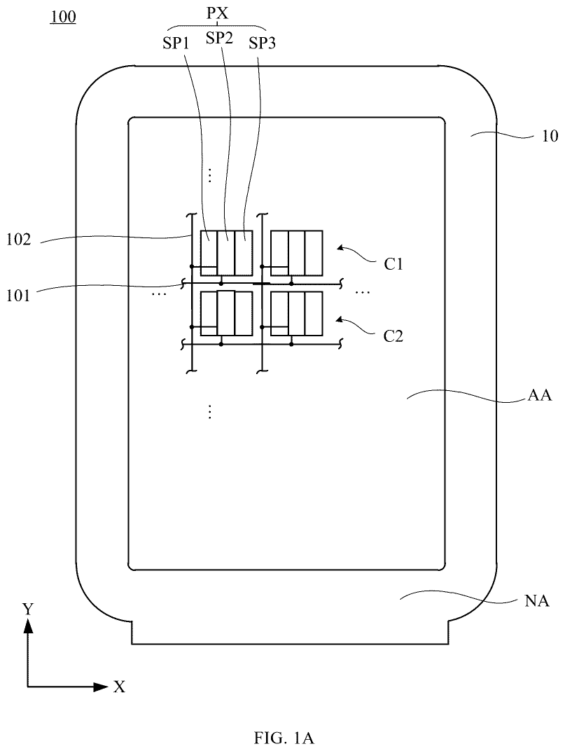

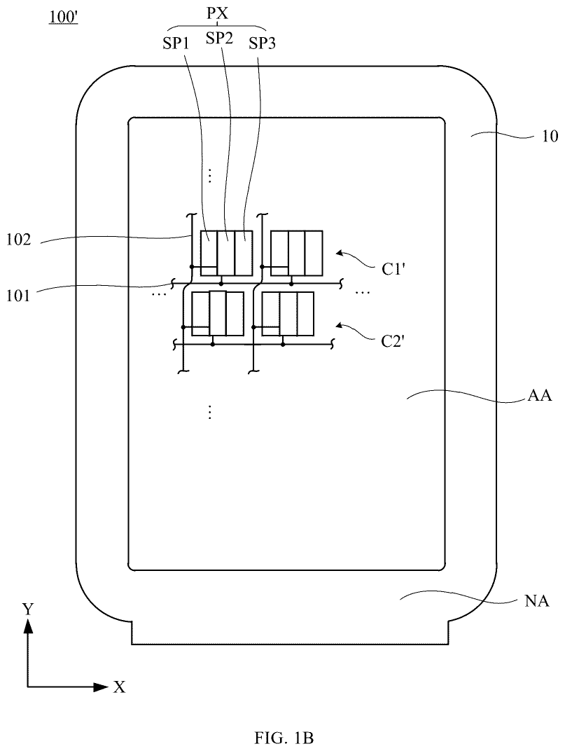

FIG. 1A shows a schematic diagram of a planar structure of a liquid crystal display substrate according to an exemplary embodiment of the present disclosure. FIG. 1B shows a schematic diagram of a planar structure of a liquid crystal display substrate according to another exemplary embodiment of the present disclosure.

As shown in FIG. 1A and FIG. 1B, a display substrate 100 and a display substrate 100′ includes a display region AA and a non-display region NA.

The display region AA may be a region in which pixel units PX for displaying images are provided. Each pixel unit PX will be described later. The non-display region NA is a region in which no pixel unit PX is provided, that is, a region in which no image is displayed. The non-display region NA corresponds to a bezel in a final display device, and a width of the bezel may be determined according to a width of the non-display region NA.

The display region AA may have various shapes. For example, the display region AA may be provided in various shapes such as a closed polygon including straight sides (e.g., a rectangle), a circle or an ellipse, etc. including a curved side, and a semicircle or a semi-ellipse, etc. including a straight side and a curved side. In the embodiments of the present disclosure, the display region AA is provided as a region having a quadrangular shape including straight sides. It should be understood that this is just an exemplary embodiment of the present disclosure, rather than a limitation to the present disclosure.

The non-display region NA may be provided on at least one side of the display region AA. In the embodiments of the present disclosure, the non-display region NA may surround a periphery of the display region AA. In the embodiments of the present disclosure, the non-display region NA may include a lateral portion extending in a first direction X and a longitudinal portion extending in a second direction Y.

The pixel unit PX is provided in the display region AA. A pixel unit PX is a minimum unit for displaying image, and a plurality of pixel units PX may be provided. For example, the pixel unit PX may include light emitting devices that emit white light and/or color light. The pixel units PX are arranged in an array in the display region, for example, arranged sequentially in the first direction X and the second direction Y. A plurality of pixel units PX may be provided in a form of a matrix along rows extending in the first direction X and columns extending in the second direction Y. However, the embodiments of the present disclosure do not specifically limit an arrangement form of the pixel units PX, and the pixel units PX may be arranged in various forms. For example, the pixel units PX may be arranged such that a direction inclined with respect to the first direction X and the second direction Y is a column direction, and a direction intersecting the column direction is a row direction.

That is, a plurality of pixel units PX are arranged in an array in the first direction X and the second direction Y, so as to form a plurality of rows of pixel units and a plurality of columns of pixel units.

A pixel unit PX may include a plurality of sub-pixels. For example, a pixel unit PX may include four sub-pixels, namely a first sub-pixel SP1, a second sub-pixel SP2, a third sub-pixel SP3, and a fourth sub-pixel SP4. The sub-pixels may have different colors or the same color. For example, the first sub-pixel SP1 and the second sub-pixel SP2 may be sub-pixels having the same color, such as blue sub-pixels, the third sub-pixel SP3 may be a red sub-pixel, and the fourth sub-pixel SP4 may be a green sub-pixel. In some embodiments of the present disclosure, the four sub-pixels may be respectively arranged in the first direction X and the second direction Y, so that a plurality of sub-pixels in a pixel unit PX are arranged in an array.

It should be noted that in the embodiments of the present disclosure, the number of sub-pixels included in a pixel unit is not particularly restricted, which is not limited to four as described above and may be more than four. In the embodiments of the present embodiment, the pixel unit in FIG. 1 is just exemplary. In the accompanying drawings used to describe the embodiments of the present disclosure, a size of the pixel unit and a size of the sub-pixel may be enlarged or reduced, that is, these accompanying drawings are not drawn according to actual scale.

For example, in the exemplary embodiment shown in FIG. 1, a signal line 101 and a data line 102 are schematically shown. That is, the liquid crystal display substrate may further include a plurality of signal lines 101 and a plurality of data lines 102 provided on the base substrate. The plurality of signal lines 101 may supply, for example, scanning control signals respectively to the plurality of rows of pixel units, and the plurality of data lines 102 may supply data signals respectively to the plurality of columns of pixel units. The signal line 101 extends in the first direction X, and the plurality of signal lines 101 are spaced apart in the second direction Y. The data line 102 extends in the second direction Y, and the plurality of data lines 102 are spaced apart in the first direction X.

For example, the signal line 110 may be a representative of lateral wires, and the data line 102 may be a representative of longitudinal wires. It should be understood that the lateral wires may further include other types of wires or wires used to supply other signals, and the longitudinal wires may further include other types of wires or wires used to supply other signals.

Each sub-pixel may include a liquid crystal layer and a driving circuit used to drive a deflection of liquid crystal in the liquid crystal layer. The driving circuit includes one or more thin film transistors, and may control the sub-pixels in the pixel unit in the liquid crystal display substrate by controlling turn-on or turn-off of the one or more thin film transistors. The sub-pixels are arranged in a matrix form on the base substrate 10 along rows extending in the first direction X and columns extending in the second direction Y.

The plurality of pixel units include a first group of pixel units C1 arranged in the first direction X and a second group of pixel units C2 arranged in the first direction X. The first group of pixel units C1 is adjacent to the second group of pixel units C2 in the second direction perpendicular to the first direction.

For example, as shown in FIG. 1A, the first group of pixel units includes, for example, a plurality of pixel units arranged in the first direction X, and the second group of pixel units includes, for example, a plurality of pixel units arranged in the first direction X. The first group of pixel units C1 and the second group of pixel units C2 are alternately arranged in the second direction Y, that is, a second group of pixel units C2 is arranged between adjacent first groups of pixel units C1. As shown in FIG. 1A, the sub-pixels in the first group of pixel units C1 are aligned with the sub-pixels in the second group of pixel units C2 in the second direction, that is, sub-pixels in adjacent rows are aligned in the second direction Y.

For another example, as shown in FIG. 1B, sub-pixels in the first group of pixel units C1′ are staggered with sub-pixels in the second group of pixel units C2′ in the second direction, that is, sub-pixels in adjacent rows are staggered with each other in the second direction Y, so as to meet different PPI. For example, it is possible to improve the PPI of the display substrate by staggering adjacent rows of sub-pixels with each other in the second direction Y.

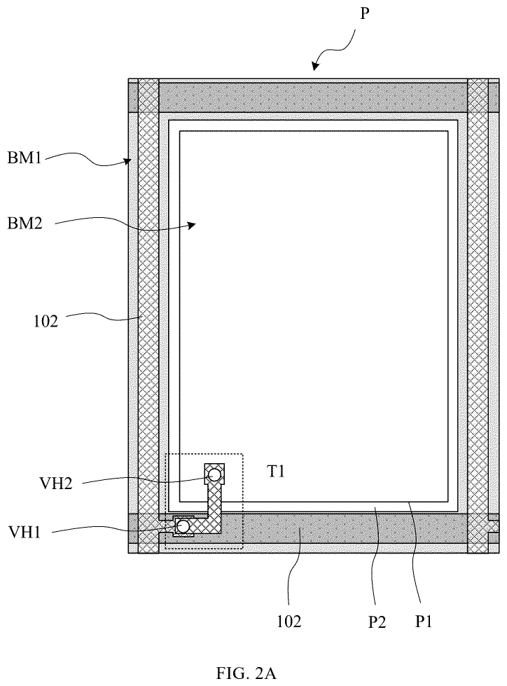

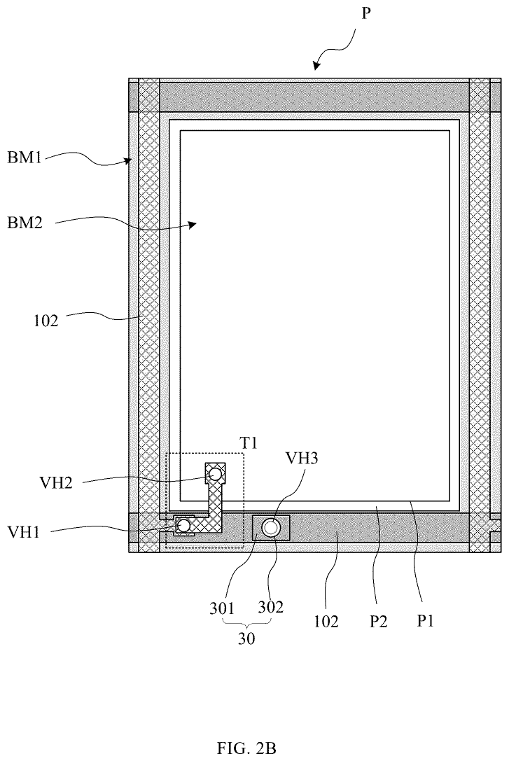

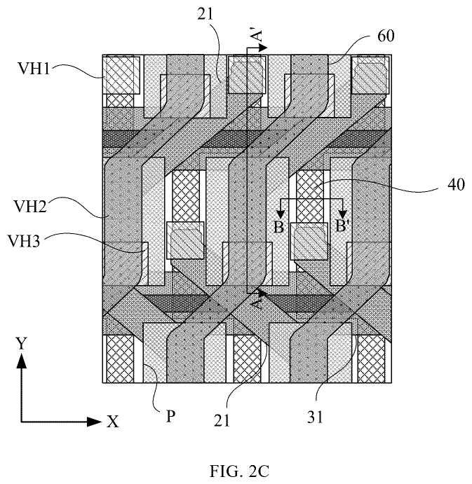

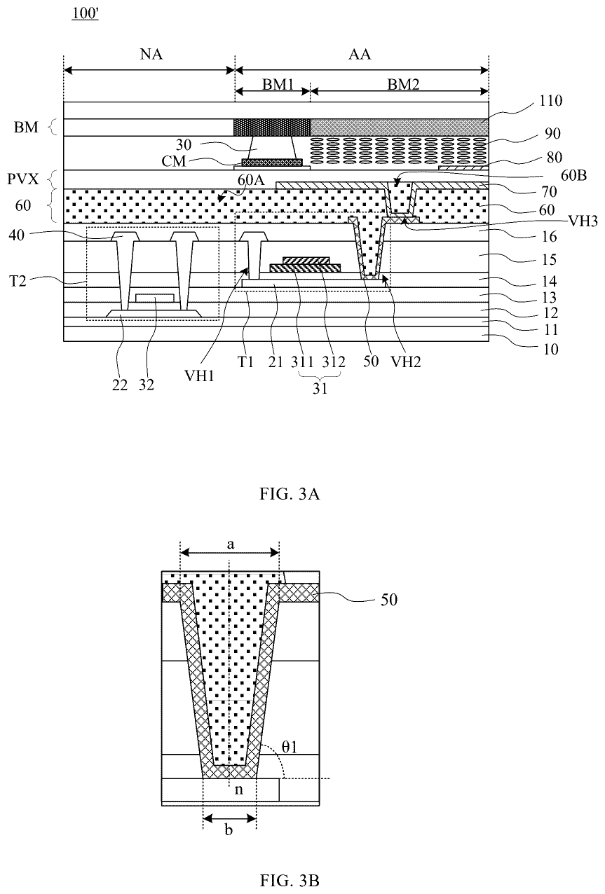

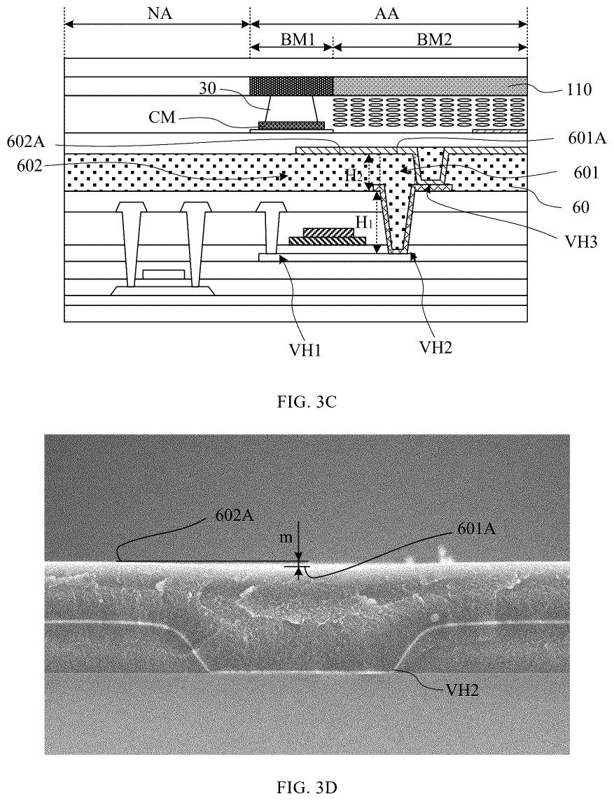

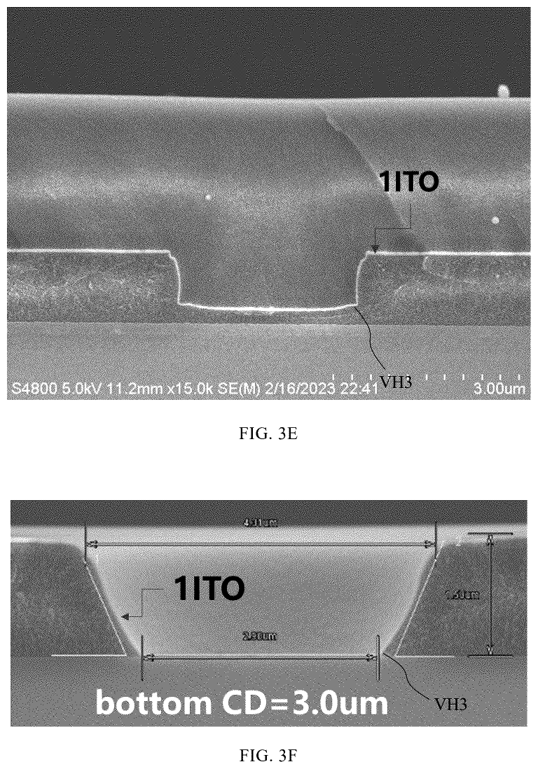

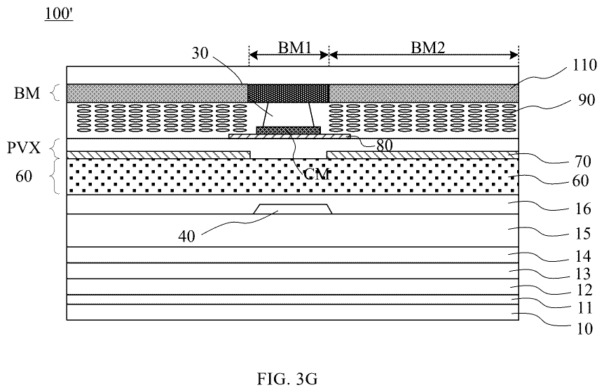

FIG. 2A shows a schematic diagram of a planar structure of a sub-pixel of the liquid crystal display substrate according to an exemplary embodiment of FIG. 1A. FIG. 2B shows a schematic diagram of a planar structure of a sub-pixel of the liquid crystal display substrate according to another exemplary embodiment of FIG. 1A. FIG. 2C shows a schematic diagram of a planar structure of a sub-pixel arrangement in the liquid crystal display substrate according to an exemplary embodiment of FIG. 1B. FIG. 3A shows a schematic diagram of a cross-sectional structure of the liquid crystal display substrate according to the exemplary embodiment of FIG. 2C taken along line A-A′.

The structure of the liquid crystal display substrate in the exemplary embodiments of the present disclosure will be described in detail below with reference to FIG. 2A, FIG. 2B, FIG. 2C and FIG. 3A.

As shown in FIG. 1A, FIG. 2A and FIG. 2B, in the liquid crystal display substrate 100, the sub-pixels in the first group of pixel units C1 are aligned with the sub-pixels in the second group of pixel units C2 in the second direction Y, that is, the sub-pixels P are aligned in both the first direction X and the second direction Y.

As shown in FIG. 1B and FIG. 2C, in the liquid crystal display substrate 100′, the sub-pixels in the first group of pixel units C1 are staggered with the sub-pixels in the second group of pixel units C2 in the second direction Y. For example, a sub-pixel P in a lower row may be arranged between two adjacent sub-pixels P in an upper row, so that a staggered space between pixels may be fully utilized for line layout, a density of the line layout may be improved, and the requirements for high PPI may be met.

As shown in FIG. 1B to FIG. 3A, the liquid crystal display substrate 100′ has a plurality of pixel units provided in the display region AA of the liquid crystal display substrate. As shown in FIG. 2C and FIG. 3A, the liquid crystal display substrate 100′ includes a first thin film transistor T1 in the display region AA and a second thin film transistor T2 in the non-display region NA. Each pixel unit includes a first thin film transistor T1, and it is possible to control a deflection of a liquid crystal material in the liquid crystal layer of the sub-pixel P through the first thin film transistor T1, so as to turn on or turn off the sub-pixel.

In the embodiments of the present disclosure, the number of the first thin film transistors T1 and the second thin film transistors T2 may be adjusted according to an actual design need of the liquid crystal display substrate, and the present disclosure does not specifically limit the number of the first thin film transistors T1 and the second thin film transistors T2.

As shown in FIG. 3A, the liquid crystal display substrate 100′ includes: a base substrate 10; a buffer layer 11 provided on a side of the base substrate 10; a first semiconductor layer 21 provided on a side of the buffer layer 11 away from the base substrate 10, where an active layer of the first thin film transistor T1 is located in the first semiconductor layer 21; a first gate layer 31 provided on a side of the first semiconductor layer 21 away from the base substrate 10, where a gate electrode G1 of the first thin film transistor T1 is located in the first gate layer 31; a first conductive layer 40 provided on a side of the first gate layer 31 away from the base substrate 10, where the first conductive layer 40 is electrically connected to the active layer of the first thin film transistor T1 through a first via hole VH1 to form a first electrode of the first thin film transistor; a second conductive layer 50 provided on a side of the first conductive layer 40 away from the base substrate 10, where the second conductive layer 50 is electrically connected to the active layer of the first thin film transistor T1 through a second via hole VH2 to form a second electrode of the first thin film transistor T1; a planarization layer 60 provided on a side of the second conductive layer 50 away from the base substrate 10, where a part of the planarization layer 60 fills the second via hole VH2; a third conductive layer 70 provided on a side of the planarization layer 60 away from the base substrate 10, where the third conductive layer 70 is electrically connected to the second conductive layer 50 through a third via hole VH3, and a pixel electrode P1 of the pixel unit is located in the third conductive layer; a passivation layer PVX provided on a side of the third conductive layer 70 away from the base substrate 10; a fourth conductive layer 80 provided on a side of the passivation layer PVX away from the base substrate 10, where a common electrode P2 of the plurality of pixel units is located in the fourth conductive layer 80; a liquid crystal layer 90 provided on a side of the fourth conductive layer 80 away from the base substrate 10, where the liquid crystal layer 90 is located in the display region AA; and a black matrix layer BM provided on a side of the liquid crystal layer 90 away from the base substrate 10, where the black matrix layer BM is located in the display region AA, and the black matrix layer BM includes a black matrix region BM1 and a black matrix opening region BM2.

In some embodiments of the present disclosure, as shown in FIG. 2C, an orthographic projection of the third via hole on the base substrate falls within an orthographic projection of the black matrix region BM1 on the base substrate, that is, the orthographic projection of the third via hole VH3 on the base substrate may overlap with, for example, an orthographic projection of the data line 102 on the base substrate, so that light in the sub-pixel may not be shielded. The orthographic projection of the third via hole VH3 on the base substrate may overlap with orthographic projections of a first supporting material layer 301 and a second supporting material layer 302 in a supporting material layer 30 on the base substrate.

In some embodiments of the present disclosure, the second conductive layer 50, the third conductive layer 70 and the fourth conductive layer 80 include a transparent conductive material, and the planarization layer 60 includes an organic transparent material, so that light rays emitted by a light emitting element may pass through the second conductive layer 50, the planarization layer 60, the third conductive layer 70 and the fourth conductive layer 80 and then be emitted from a light emitting side of the liquid crystal display substrate, and a brightness of the liquid crystal display substrate may be ensured. In the embodiments of the present disclosure, an orthographic projection of the second via hole VH2 on the base substrate 10 falls within an orthographic projection of the black matrix opening region BM2 on the base substrate. The liquid crystal layer 90 is provided on a side of the black matrix opening region BM2 close to the base substrate. When a liquid crystal in the liquid crystal layer 90 is controlled by the first thin film transistor to deflect, light rays may be emitted from the black matrix opening region BM2. By providing the second via hole VH2, as well as providing the second conductive layer 50 using a transparent conductive material, it is possible to avoid shielding the emitted light rays, so that an opening ratio of the sub-pixel may be effectively improved, and the design of the liquid crystal display substrate with high PPI may be met.

As shown in FIG. 3A, the liquid crystal display substrate 100′ further includes a second semiconductor layer 22 and a second gate layer 32, the second semiconductor layer 22 is provided on a side of the buffer layer 11 away from the base substrate 10, and the second gate layer 32 is provided on a side of the second semiconductor layer 22 away from the base substrate 10. Insulation layers are further provided between various film layers. For example, a first gate insulation layer 12 is provided between the buffer layer 11 and the second semiconductor layer 22, a first interlayer insulation layer 13 is provided between the second gate layer 32 and the first semiconductor layer 21, a second gate insulation layer 14 is provided between the first semiconductor layer 21 and the first gate layer 31, a second interlayer insulation layer 15 is provided between the first gate layer 31 and the first conductive layer 40, and a third interlayer insulation layer 16 is provided between the first conductive layer 40 and the second conductive layer 50.

An active layer of the second thin film transistor T2 is located in the second semiconductor layer 22, a gate electrode G2 of the second thin film transistor T2 is located in the second gate layer 32, and the second semiconductor layer 22 is communicated with the first conductive layer 40 through a via hole to form a source electrode or a drain electrode of the second thin film transistor T2.

As shown in FIG. 3A, an orthographic projection of the first thin film transistor T1 on the base substrate 10 overlaps with the orthographic projection of the black matrix opening region BM2 on the base substrate, that is, a part of the first thin film transistor T1 extends into the sub-pixel, and the orthographic projection of the first thin film transistor T1 on the base substrate 10 overlaps with the orthographic projection of the black matrix region BM1 on the base substrate. According to the embodiments of the present disclosure, by providing a part of the first thin film transistor T1 in the sub-pixel, it is possible to effectively improve the pixel opening ratio of the sub-pixel and save a space of the driving circuit, so as to meet the design requirements for high PPI.

The first gate layer includes a first gate sub-layer and a second gate sub-layer, and at least one of the first gate sub-layer and the second gate sub-layer includes a transparent conductive material.

For example, the first gate layer 31 includes a first gate sub-layer 311 close to the base substrate and a second gate sub-layer 312 away from the base substrate, and the first gate sub-layer 311 is in contact with the second gate sub-layer 312 to achieve an electrical connection. The first gate sub-layer 311 is a transparent conductive material, and the second gate sub-layer 312 is a non-transparent conductive material. In the embodiment, since the orthographic projection of the first thin film transistor T1 on the base substrate 10 overlaps with the orthographic projection of the black matrix opening region BM2 on the base substrate, the first gate sub-layer 311 is provided as a transparent conductive material (such as indium tin oxide) so as to avoid shielding the light rays. Compared with a gate electrode using a traditional metal material, the transparent conductive material may avoid shielding light rays but has a larger resistance. With an increase of distance, a voltage drop may be obvious, which may result in a poor display uniformity of the liquid crystal display substrate. In order to solve such problem, in the embodiment, the first gate layer is provided as a multi-layer structure including the first gate sub-layer and the second gate sub-layer, and at least one of the first gate sub-layer and the second gate sub-layer includes a transparent conductive material, so that the light shielding of the first thin film transistor T1 may be reduced while the display uniformity of the liquid crystal display substrate may be improved.

As shown in FIG. 3A, the second via hole VH2 sequentially penetrates the second gate insulation layer 14, the second interlayer insulation layer 15 and the third interlayer insulation layer 16, and exposes the active layer of the first thin film transistor T1. The second via hole VH2 includes a first end away from the base substrate and a second end close to the base substrate, and a via hole opening area of the second via hole parallel to an upper surface of the base substrate gradually decreases from the first end to the second end.

As shown in FIG. 2C and FIG. 3A, the first semiconductor layer 21 is inclined with respect to the first direction X and the second direction Y, the first gate layer 31 extends in the first direction X, and the first conductive layer 40 surrounds a periphery of the sub-pixel P. An orthographic projection of the first via hole VH1 on the base substrate falls within the orthographic projection of the black matrix region BM1 on the base substrate. The orthographic projections of the second via hole VH2 and the third via hole VH3 on the base substrate fall within the orthographic projection of the black matrix opening region BM2 on the base substrate. The planarization layer 60 is used for planarization of the second via hole VH2 and the third via hole VH3. In the embodiment, through the above-mentioned arrangement, a wire space may be effectively utilized so as to meet the requirements for high PPI.

FIG. 3B shows a schematic diagram of a cross-sectional structure at a second via hole of the liquid crystal display substrate according to an exemplary embodiment of the present disclosure.

As shown in FIG. 3A and FIG. 3B, a sidewall section line of the second via hole VH2 has a first angle θ1 with the upper surface of the base substrate, where 45°<θ1<90°. The sidewall section line of the second via hole is obtained by intersecting a sidewall of the second via hole and a section where symmetry axis of the second via hole is located. For example, the symmetry axis of the second via hole is n, the second via hole is a truncated cone, and a symmetry axis of the truncated cone is n. The sidewall section line of the second via hole is axisymmetric with respect to the symmetry axis n.

Exemplarily, 50°≤θ1≤89°. For example, θ1≥52° may ensure a good effect in preventing light leakage. For example, θ1≥85° may have an excellent effect in preventing light leakage.

In some embodiments of the present disclosure, a slope change rate of the sidewall section line close to the first end is greater than a slope change rate of the sidewall section line close to the second end.

Exemplarily, a profile of the sidewall section line is an arc, and as getting close to the second end, an angle between the sidewall section line and the upper surface of the base substrate is greater than an angle between the sidewall section line at the first end and the upper surface of the base substrate.

As shown in FIG. 3B, the first end of the second via hole has a via width a, and the second end of the second via hole has a via width b, where 2.5 μm≤a≤4.5 μm, 1.5 μm≤b≤3.5 μm.

For example, a=4.2 μm, b=3 μm. For another example, a=2.8 μm, b=2.5 μm.

FIG. 3C shows a schematic diagram of a cross-sectional structure at the second via hole of the planarization layer of the liquid crystal display substrate according to an exemplary embodiment of the present disclosure. FIG. 3D shows a morphology diagram of a cross-sectional structure at the second via hole of the planarization layer of the liquid crystal display substrate according to an exemplary embodiment of the present disclosure.

As shown in FIG. 3C and FIG. 3D, the planarization layer 60 includes a first planarization region 601 and a second planarization region 602. An orthographic projection of the first planarization region 601 on the base substrate falls within the orthographic projection of the second via hole VH2 on the base substrate 10, and the second planarization region 602 is a region outside the first planarization region. That is, the first planarization region 601 corresponds to the second via hole VH2, and the second planarization region 602 is a region of the planarization layer 60 other than the first planarization region 601.

The first planarization region 601 includes a first planarization surface 601A away from the second conductive layer, and the second planarization region 602 includes a second planarization surface 602A away from the second conductive layer. A segment difference m between the first planarization surface 601A and the second planarization surface 602A is less than 0.2 μm.

According to the embodiments of the present disclosure, the segment difference between the first planarization surface 601A and the second planarization surface 602A is associated with a shape of the second via hole VH2. By providing the second via hole VH2 as the above-mentioned morphology, the segment difference between the first planarization surface 601A and the second planarization surface 602A may be less than 0.2 μm, so that a surface of the planarization layer on a side away from the base substrate has a good flatness. The third conductive layer 70 is provided in the black matrix opening region BM2 and on the planarization layer 60, so as to ensure that the black matrix opening region is completely flat, thereby achieving the liquid crystal display substrate with high brightness and high PPI while effectively reducing the light leakage.

As shown in FIG. 3A, the orthographic projection of the third via hole VH3 on the base substrate 10 falls within the orthographic projection of the black matrix opening region BM2 on the base substrate 10. The third via hole VH3 penetrates the planarization layer 60 and exposes the second conductive layer 50. A part of the third conductive layer 70 fills the third via hole VH3.

The planarization layer 60 includes a first planarization sub-portion 60A and a second planarization sub-portion 60B. That is, the planarization layer 60 is provided as one layer. A part of the second conductive layer 50 and a part of the first planarization sub-portion 60A fill the second via hole VH2. A part of the third conductive layer 70 and the second planarization sub-portion 60B fill the third via hole VH3, and an orthographic projection of the second planarization sub-portion 60B on the base substrate 10 falls within the orthographic projection of the third via hole VH3 on the base substrate 10.

FIG. 3E shows a morphology diagram of a cross-sectional structure at the third via hole of the liquid crystal display substrate according to an exemplary embodiment of the present disclosure. FIG. 3F shows a morphology diagram of a cross-sectional structure at the third via hole of the liquid crystal display substrate according to another exemplary embodiment of the present disclosure.

As shown in FIG. 3E and FIG. 3F, the third via hole VH3 has the same shape as the second via hole VH2.

For example, the third via hole includes a first end away from the base substrate and a second end close to the base substrate, and a via hole opening area of the third via hole parallel to the upper surface of the base substrate gradually decreases from the first end to the second end. A sidewall section line of the third via hole has a second angle θ2 with the upper surface of the base substrate, where 45°<θ2<90°. The sidewall section line of the third via hole is obtained by intersecting a sidewall of the third via hole and a section where a symmetry axis of the third via hole is located. A slope change rate of the sidewall section line close to the first end of the third via hole is greater than a slope change rate of the sidewall section line close to the second end of the third via hole. The first end of the third via hole has a via width c, and the second end of the third via hole has a via width d, where 2.5 μm≤c≤4.5 μm, 1.5 μm≤d≤3.5 μm. For example, as shown in FIG. 3F, c=4.2 μm, and d=3 μm.

In some embodiments of the present disclosure, as shown in FIG. 3C, in a direction perpendicular to the upper surface of the base substrate, a depth H₁ of the second via hole VH2 and a thickness H₂ of the planarization layer meet a linear relationship of: H₁=A×H₂+0.2, where 0.4≤A≤0.6.

According to the embodiments of the present disclosure, by providing the depth of the second via hole VH2 and the thickness of the planarization layer as meeting the above-mentioned linear relationship, the planarization layer may fill the second via hole VH2 well when the planarization layer is used for planarization of the second via hole VH2, so that the segment difference between the first planarization surface 601A and the second planarization surface 602A may be less than 0.2 μm so as to ensure a good flatness.

As shown in FIG. 3A, the liquid crystal display substrate 100′ further includes the supporting material layer 30 and a light shielding layer CM.

The supporting material layer 30 is provided between the passivation layer PVX and the black matrix layer BM to separate the pixel unit into a plurality of sub-pixels. An orthographic projection of the supporting material layer 30 on the base substrate 10 falls within the orthographic projection of the black matrix region BM1 on the base substrate 10.

The light shielding layer CM is provided between the supporting material layer 30 and the passivation layer PVX. An orthographic projection of the light shielding layer CM on the base substrate falls within the orthographic projection of the black matrix region BM1 on the base substrate.

As shown in FIG. 3A, the liquid crystal display substrate 100′ further includes a color filter layer 110 in the same layer as the black matrix layer BM, and an orthographic projection of the color filter layer 110 on the base substrate falls within the orthographic projection of the black matrix opening region BM2 on the base substrate.

As shown in FIG. 3A, the non-COA (CF On Array) technology is adopted for the color filter layer 110. By providing the color filter layer 110 in the same layer as the black matrix layer BM, it is possible to effectively reduce a thickness of the planarization layer 60, so as to reduce an overall thickness of the liquid crystal display substrate and achieve a thinning design, while ensuring the high PPI and the display uniformity of the liquid crystal display substrate.

In some other embodiments of the present disclosure, the COA technology is adopted for the color filter layer, that is, the color filter layer is located in the same layer as the planarization layer, and the orthographic projection of the color filter layer on the base substrate falls within the orthographic projection of the black matrix opening region on the base substrate.

FIG. 3G shows a schematic diagram of a cross-sectional structure of the liquid crystal display substrate according to the exemplary embodiment of FIG. 2C taken along line B-B′.

As shown in FIG. 3G, a cross section of the liquid crystal display substrate 100′ taken along line B-B′ includes the base substrate 10, the buffer layer 11, the first gate insulation layer 12, the first interlayer insulation layer 13, the second gate insulation layer 14, the second interlayer insulation layer 15, the first conductive layer 40, the third interlayer insulation layer 16, the planarization layer 60, the third conductive layer 70, the fourth conductive layer 80, the liquid crystal layer 90 and the black matrix layer BM that are arranged sequentially. The black matrix layer BM includes the black matrix region BM1 and the black matrix opening region BM2. In this cross section, an orthographic projection of the first conductive layer 40 on the base substrate falls within the orthographic projection of the black matrix region BM1 on the base substrate.

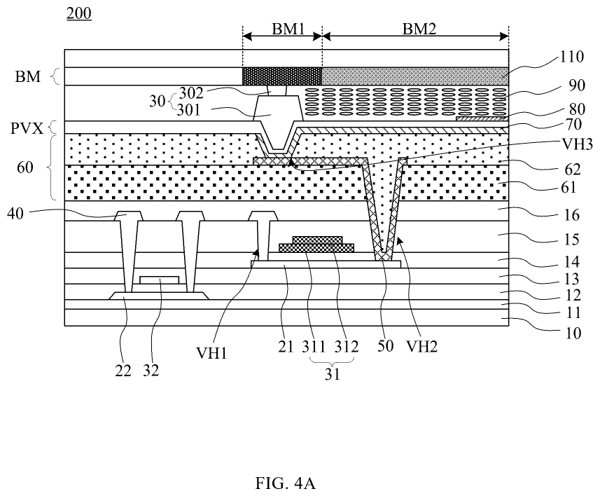

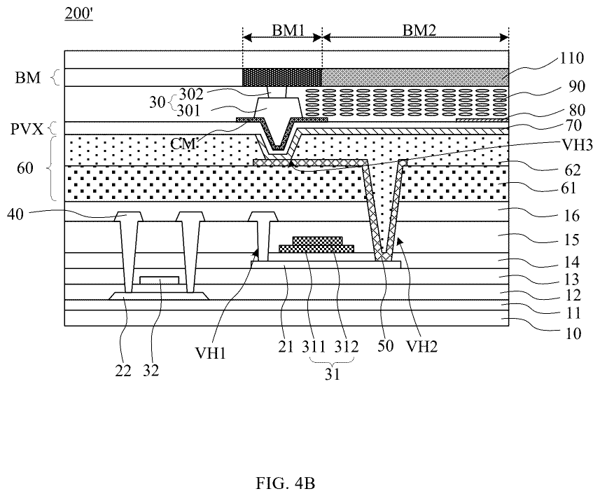

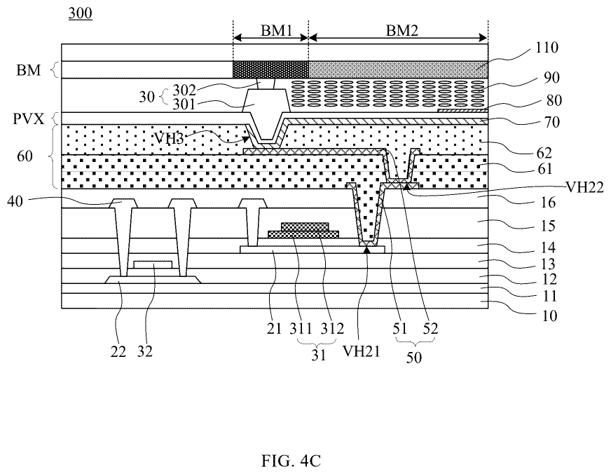

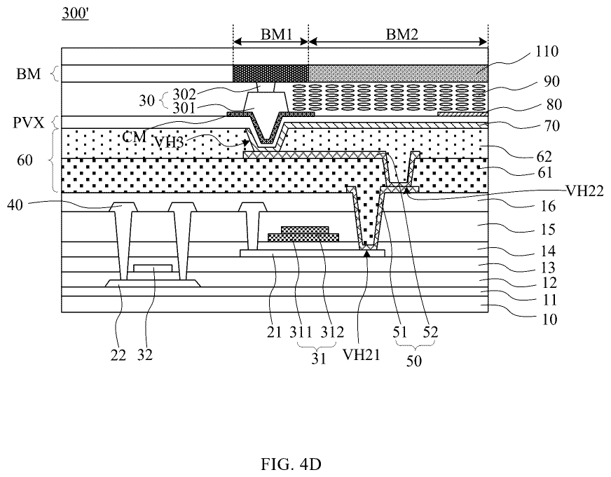

FIG. 4A shows a schematic diagram of a cross-sectional structure of a liquid crystal display substrate 200 according to another exemplary embodiment of the present disclosure. FIG. 4B shows a schematic diagram of a cross-sectional structure of a liquid crystal display substrate 200′ including a light shielding layer according to another exemplary embodiment of the present disclosure.

As shown in FIG. 4A and FIG. 4B, in the liquid crystal display substrate 200 and the liquid crystal display substrate 200′, the orthographic projection of the third via hole VH3 on the base substrate 10 falls within the orthographic projection of the black matrix region BM1 on the base substrate. The orthographic projection of the second via hole VH2 on the base substrate 10 falls within the orthographic projection of the black matrix opening region BM2 on the base substrate. The third via hole VH3 may not shield the light rays, so that a display light output and a display brightness of the liquid crystal display substrate may be further improved.

The planarization layer 60 includes a first planarization layer 61 close to the second conductive layer 50 and a second planarization layer 62 away from the second conductive layer.

The second via hole VH2 penetrates the first planarization layer 61 and exposes the active layer of the first thin film transistor T1, and a part of the second conductive layer 50 and a part of the planarization layer fill the second via hole VH2. For example, the second via hole VH2 sequentially penetrates the first planarization layer 61, the third interlayer insulation layer 16, the second interlayer insulation layer 15 and the second gate insulation layer 14 so as to expose the first semiconductor layer 21. A part of the second planarization layer 62 and a part of the second conductive layer 50 fill the second via hole VH2.

The third via hole VH3 penetrates the second planarization layer 62 and exposes the second conductive layer 50, and a part of the passivation layer PVX and a part of the supporting material layer 30 fill the third via hole.

As shown in FIG. 4A and FIG. 4B, the supporting material layer 30 includes the first supporting material layer 301 close to the passivation layer PVX and the second supporting material layer 302 away from the passivation layer PVX, the orthographic projection of the third via hole VH3 on the base substrate 10 falls within the orthographic projection of the first supporting material layer 301 on the base substrate 10, and a part of the first supporting material layer 301 fills the third via hole VH3.

For example, the first supporting material layer 301 may be Pillow, and a thickness of the first supporting material layer may be reduced through a half tone Mask process. The second supporting material layer may be PS. PS and Pillow are aligned to support each other, so that PS and Pillow on two sides are self-aligned, thus avoiding the light leakage and improving brightness and contrast.

As shown in FIG. 4B, the liquid crystal display substrate 200′ further includes a light shielding layer CM. The light shielding layer CM is provided between the supporting material layer 30 and the passivation layer PVX, and an orthographic projection of the light shielding layer CM on the base substrate falls within the orthographic projection of the black matrix region BM1 on the base substrate.

For example, the light shielding layer CM is provided between the first supporting material 301 and the passivation layer PVX, and a part of the light shielding layer CM fills the third via hole VH3 together with the passivation layer PVX. By providing the light shielding layer CM, it is possible to reduce an alignment error between the black matrix layer and a lower film layer, effectively reduce the light leakage and improve the display brightness and contrast of the liquid crystal display substrate.

FIG. 4C shows a schematic diagram of a cross-sectional structure of a liquid crystal display substrate 300 according to another exemplary embodiment of the present disclosure. FIG. 4D shows a schematic diagram of a cross-sectional structure of a liquid crystal display substrate 300′ including a light shielding layer according to another exemplary embodiment of the present disclosure.

As shown in FIG. 4C and FIG. 4D, the liquid crystal display substrate 300 and the liquid crystal display substrate 300′ include interlayer insulation layers provided between the first semiconductor layer and the planarization layer, including the second gate insulation layer 14, the second interlayer insulation layer 15 and the third interlayer insulation layer 16.

The second via hole includes a first via sub-hole VH21 and a second via sub-hole VH22. The second conductive layer includes a first conductive sub-layer 51 close to the base substrate and a second conductive sub-layer 52 away from the base substrate.

The first via sub-hole VH21 penetrates the second gate insulation layer 14, the second interlayer insulation layer 15 and the third interlayer insulation layer 16 and exposes the active layer of the first thin film transistor. A part of the first conductive sub-layer 51 and a part of the first planarization layer 61 fill the first via sub-hole VH21.

The second via sub-hole VH22 penetrates the first planarization layer 61 and exposes the first conductive sub-layer 51. A part of the second conductive sub-layer 52 and a part of the second planarization layer 62 fill the second via sub-hole VH22.

As shown in FIG. 4D, the liquid crystal display substrate 300′ further includes the light shielding layer CM. The light shielding layer CM is provided between the supporting material layer 30 and the passivation layer PVX, and the orthographic projection of the light shielding layer CM on the base substrate falls within the orthographic projection of the black matrix region BM1 on the base substrate.

For example, the light shielding layer CM is provided between the first supporting material layer 301 and the passivation layer PVX, and a part of the light shielding layer CM fills the third via hole VH3 together with the passivation layer PVX. By providing the light shielding layer CM, it is possible to reduce the alignment error between the black matrix layer and the lower film layer, effectively reduce the light leakage and improve the display brightness and contrast of the liquid crystal display substrate.

In some embodiments of the present disclosure, when the planarization layer includes the first planarization layer and the second planarization layer, a total thickness of the planarization layer may increase a vertical distance between each conductive layer, thereby effectively reducing a parasitic capacitance, reducing crosstalk and noise, and improving the display effect of the liquid crystal display substrate.

In the embodiments of the present disclosure, the non-COA technology is adopted for the liquid crystal display substrates 100, 100′, 200, 200′, 300 and 300′, that is, the color filter layer 110 is provided in the same layer as the black matrix layer BM, and the orthographic projection of the color filter layer 110 on the base substrate falls within the orthographic projection of the black matrix opening region BM2 on the base substrate.

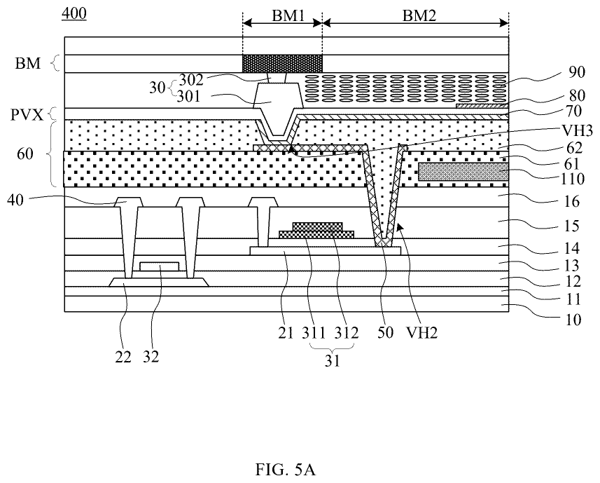

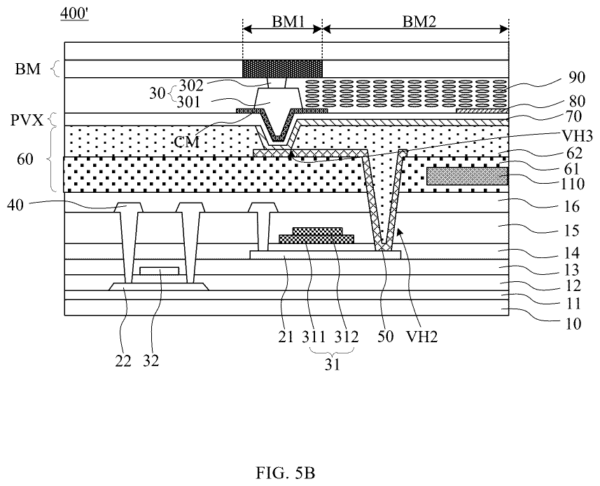

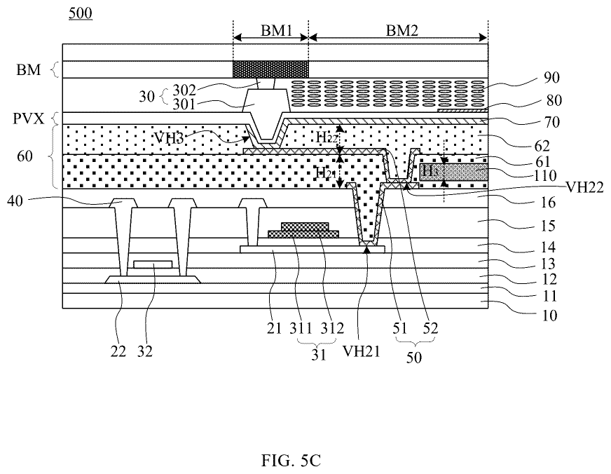

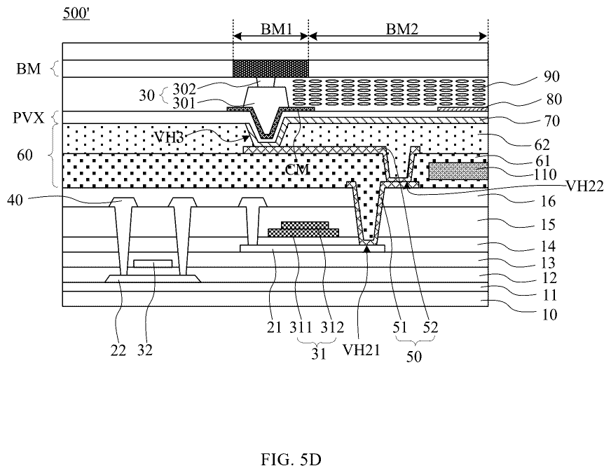

FIG. 5A shows a schematic diagram of a cross-sectional structure of a liquid crystal display substrate 400 according to another exemplary embodiment of the present disclosure. FIG. 5B shows a schematic diagram of a cross-sectional structure of a liquid crystal display substrate 400′ including a light shielding layer according to another exemplary embodiment of the present disclosure. FIG. 5C shows a schematic diagram of a cross-sectional structure of a liquid crystal display substrate 500 according to another exemplary embodiment of the present disclosure. FIG. 5D shows a schematic diagram of a cross-sectional structure of a liquid crystal display substrate 500′ including a light shielding layer according to another exemplary embodiment of the present disclosure.

As shown in FIG. 5A, FIG. 5B, FIG. 5C and FIG. 5D, the color filter layer 110 of the liquid crystal display substrate is located in the same layer as the planarization layer 60, and the orthographic projection of the color filter layer 110 on the base substrate 10 falls within the orthographic projection of the black matrix opening region BM2 on the base substrate 10. That is, the COA technology is adopted for the liquid crystal display substrates in FIG. 5A to FIG. 5D, that is, the CF (Color filter) is provided on the array substrate, which involves no alignment operation, thus achieving the high PPI. Meanwhile, the planarization of the color filter layer is performed through the first planarization layer and the second planarization layer, so that a side of the planarization layer away from the base substrate may have a higher flatness, and the display uniformity may be improved.

FIG. 5A corresponds to FIG. 4A, FIG. 5B corresponds to FIG. 4B, FIG. 5C corresponds to FIG. 4C, and FIG. 5D corresponds to FIG. 4D. These embodiments differ in positions of the color filter layer 110, and a better flatness and display uniformity may be achieved.

As shown in FIG. 5C and FIG. 5D, in the liquid crystal display substrates 500 and 500′, a thickness H₃ of the color filter layer 110, a thickness H₂₁ of the first planarization layer and a thickness H₂₂ of the second planarization layer meet a relationship of: H₂₁+H₂₂>H₃.

After the color filter layer 110 is formed on a side of the first conductive sub-layer 51 away from the base substrate 10, a planarization is performed on the first via sub-hole VH21 and the color filter layer 110 firstly by the first planarization layer 61, for example, the thickness of the first planarization layer 61 may be 1.0 μm. The second planarization layer 62 is formed on a side of the first planarization layer 61 away from the base substrate, a secondary planarization is performed on the second via sub-hole VH22 and the color filter layer 110 by the second planarization layer, for example, the thickness of the second planarization layer 62 may be 3 μm. For example, the thickness of the color filter layer 110 may be 2.1 μm. Therefore, a sum of the thickness of the first planarization layer 61 and the thickness of the second planarization layer 62 is greater than the thickness of the color filter layer 110. Through two-time planarization, it is possible to achieve a good planarization effect and improve the display uniformity of the liquid crystal display substrate. In addition, the first planarization layer and the second planarization layer may increase a distance between conductive layers, effectively reduce the parasitic capacitance and further reduce crosstalk and noise, thereby further improving the display effect.

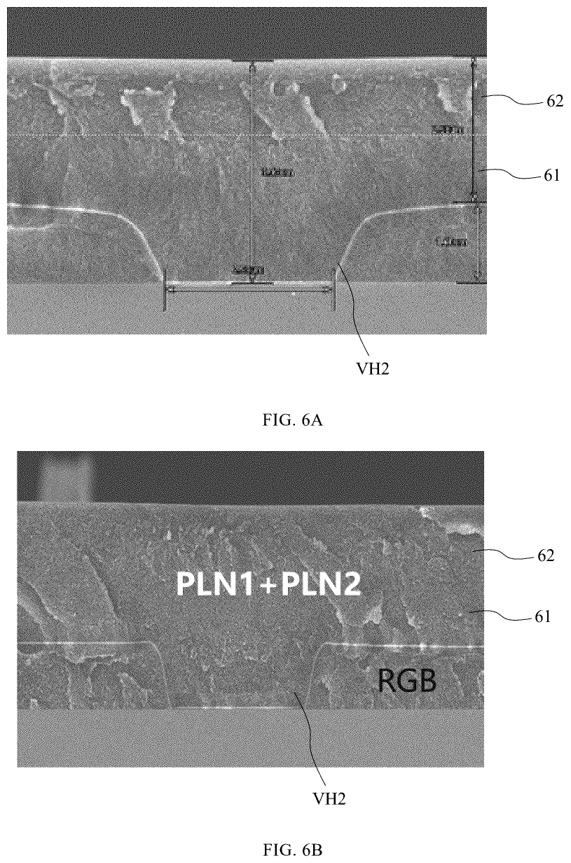

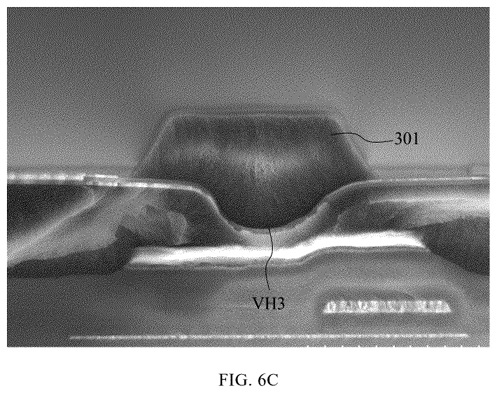

FIG. 6A shows a morphology diagram of a cross-sectional structure at the second via hole of the liquid crystal display substrate according to an exemplary embodiment of the present disclosure. FIG. 6B shows a morphology diagram of a cross-sectional structure at the second via hole of the liquid crystal display substrate according to another exemplary embodiment of the present disclosure. FIG. 6C shows a morphology diagram of a cross-sectional structure at the third via hole of the first supporting material layer of the liquid crystal display substrate according to an exemplary embodiment of the present disclosure.

As shown in FIG. 6A and FIG. 6B, planarization is respectively performed on the liquid crystal display substrate, by the first planarization layer 61 and the second planarization layer 62, on a side of the second via hole away from the base substrate, so as to achieve a good planarization effect. For example, as shown in FIG. 6A, the thickness of the first planarization layer 61 in the direction perpendicular to the upper surface of the base substrate is 1.5 μm, and the thickness of the second planarization layer 62 in the direction perpendicular to the upper surface of the base substrate is 2.5 μm. After planarization, the segment difference between the first planarization surface of the first planarization region corresponding to the second via hole VH2, and the second planarization surface of the second planarization region is 0.05 μm, which achieves a good planarization effect. As shown in FIG. 6B, after planarization, the segment difference between the first planarization surface of the first planarization region corresponding to the second via hole VH2 and the second planarization surface of the second planarization region is 0.04 μm, which also achieves a good planarization effect. The COA technology is adopted for the crystal liquid display substrates shown in FIG. 6A and FIG. 6B, in which the planarization is performed by the first planarization layer and the second planarization layer, so as to ensure an excellent planarization effect.

As shown in FIG. 6C, the first supporting material layer 301 in the supporting material layer may be manufactured at the third via hole of the liquid crystal display substrate through a half tone process.

In another aspect of the present disclosure, a method of manufacturing a liquid crystal display substrate is further provided. The liquid crystal display substrate includes a plurality of pixel units arranged in a display region, and the pixel unit includes a first thin film transistor. The method includes operation S1 to operation S12.

In operation S1, a base substrate is provided.

In operation S2, a first semiconductor layer is formed on a side of the base substrate, where an active layer of the first thin film transistor is located in the first semiconductor layer.

In operation S3, a first gate layer is formed on a side of the first semiconductor layer away from the base substrate, where a gate electrode of the first thin film transistor is located in the first gate layer.

In operation S4, a first conductive layer is formed on a side of the first gate layer away from the base substrate, where the first conductive layer is electrically connected to the active layer of the first thin film transistor through a first via hole to form a first electrode of the first thin film transistor.

In operation S5, a second via hole is formed to expose the active layer of the first thin film transistor.

In operation S6, a second conductive layer is formed on a side of the first conductive layer away from the base substrate, where the second conductive layer is electrically connected to the active layer of the first thin film transistor through the second via hole to form a second electrode of the first thin film transistor.

In operation S7, a planarization layer is formed on a side of the second conductive layer away from the base substrate, where a part of the planarization layer fills the second via hole.

In operation S8, a third conductive layer is formed on a side of the planarization layer away from the base substrate, where the third conductive layer is electrically connected to the second conductive layer through a third via hole, and a pixel electrode of the pixel unit is located in the third conductive layer.

In operation S9, a passivation layer is formed on a side of the third conductive layer away from the base substrate.

In operation S10, a fourth conductive layer is formed on a side of the passivation layer away from the base substrate, where a common electrode of the plurality of pixel units is located in the fourth conductive layer.

In operation S11, a liquid crystal layer is formed on a side of the fourth conductive layer away from the base substrate, where the liquid crystal layer is located in the display region.

In operation S12, a black matrix layer is formed on a side of the liquid crystal layer away from the base substrate, where the black matrix layer is located in the display region, and the black matrix layer includes a black matrix region and a black matrix opening region. The second conductive layer, the third conductive layer and the fourth conductive layer include a transparent conductive material, and an orthographic projection of the second via hole on the base substrate falls within an orthographic projection of the black matrix opening region on the base substrate.

Exemplarily, the operation of forming the second via hole to expose the active layer of the first thin film transistor includes: etching an insulation layer on a side of the first conductive layer away from the base substrate to form the second via hole so as to expose the active layer of the first thin film transistor. The second via hole includes a first end away from the base substrate and a second end close to the base substrate, and a via hole opening area of the second via hole parallel to an upper surface of the base substrate gradually decreases from the first end to the second end.

A sidewall section line of the second via hole has a first angle θ1 with the upper surface of the base substrate, where 45°<θ1<90°. The sidewall section line of the second via hole is obtained by intersecting a sidewall of the second via hole and a section where a symmetry axis of the second via hole is located. A slope change rate of the sidewall section line close to the first end is greater than a slope change rate of the sidewall section line close to the second end.

The first end of the second via hole has a via width a, and the second end of the second via hole has a via width b, where 2.5 μm≤a≤4.5 μm, 1.5 μm≤b≤3.5 μm.

In some embodiments of the present disclosure, the operation of forming the planarization layer on a side of the second conductive layer away from the base substrate includes: drying and curing the planarization layer, where a heating rate of the drying and curing is in a range of 5° C./min to 15° C./min, so as to ensure that the via hole penetrating the planarization layer meets the first angle range, thereby achieving the effect of avoiding light leakage.

In some embodiments of the present disclosure, the method of manufacturing the liquid crystal display substrate may include, for example, the following formation processes. First, a base substrate is provided, a buffer layer is formed on the base substrate, a second semiconductor layer 22 is formed on the buffer layer, a second gate layer 32 is formed on a side of the second semiconductor layer 22 away from the base substrate, a first semiconductor layer 21 is formed, and a first gate layer 31 is formed on a side of the first semiconductor layer 21 away from the base substrate. Then, via holes for connections with the second semiconductor layer 22 and the first semiconductor layer 21 are formed, a first conductive layer 40 is respectively formed in the via holes. A first gate insulation layer 12, a first interlayer insulation layer 13, a second gate insulation layer 14 and a second interlayer insulation layer 15 are further formed. After forming the first conductive layer 40, a third interlayer insulation layer 16 is formed on a side of the first conductive layer 40 away from the base substrate. Next, a first via sub-hole VH21 is formed on a side of the third interlayer insulation layer 16 away from the base substrate, where the first via sub-hole VH21 penetrates the second gate insulation layer 14, the second interlayer insulation layer 15 and the third interlayer insulation layer 16 and exposes the first semiconductor layer 21. Then, a first conductive sub-layer 51 is formed in the first via sub-hole VH21. After that, planarization is performed on the first via sub-hole VH21 through a first planarization layer 61, and a second via sub-hole is then formed on the first planarization layer 61.

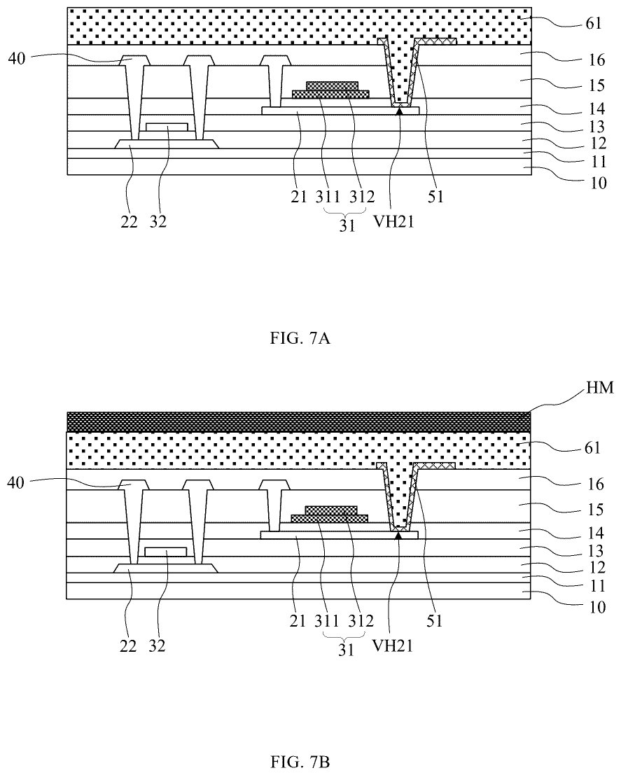

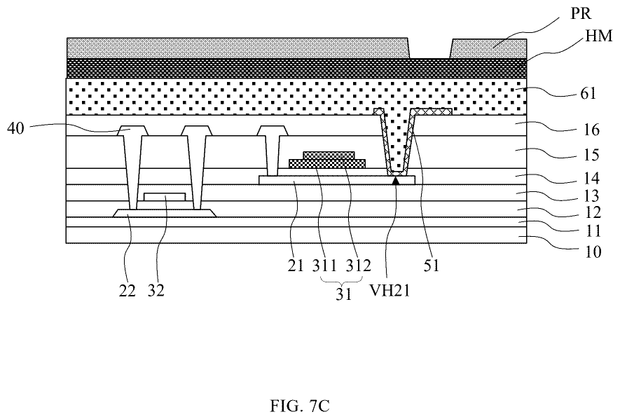

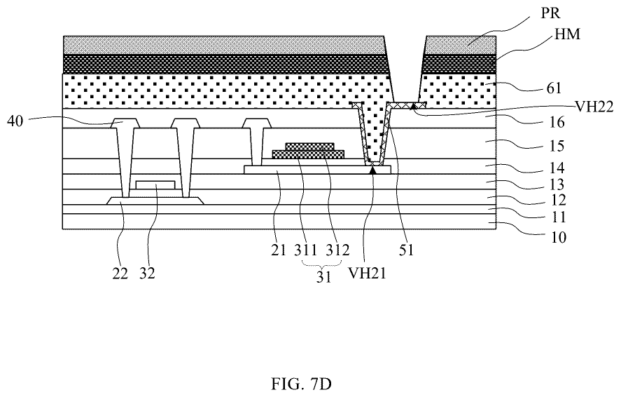

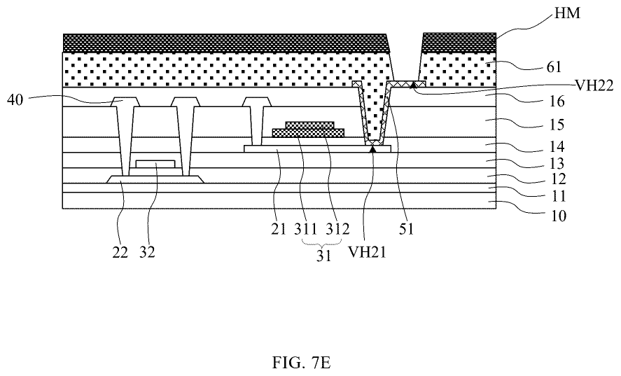

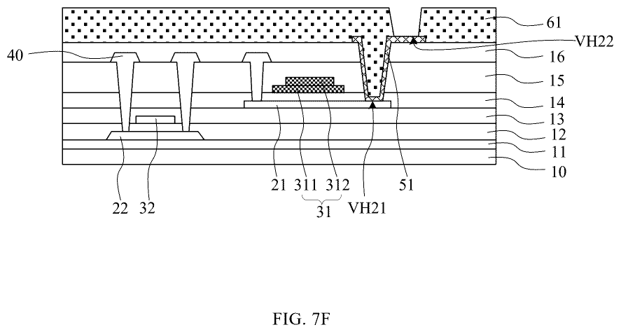

FIG. 7A to FIG. 7F show flowcharts of a manufacturing process of the second via hole of the liquid crystal display substrate according to an exemplary embodiment of the present disclosure.

The process of forming the second via sub-hole in the second via hole VH2 includes the following steps.

As shown in FIG. 7A, the first planarization layer 61 fills the first via sub-hole VH21 in the second via hole.

As shown in FIG. 7B, a hard mask HM is formed on a side of the first planarization layer 61 away from the base substrate, for example, by CVD (Chemical Vapor Deposition).

As shown in FIG. 7C, a photoresist PR is formed on a side of the hard mask HM away from the base substrate, the photoresist is exposed to achieve development of a region corresponding to the second via sub-hole VH22.

As shown in FIG. 7D, the hard mask and the first planarization layer 61 in the region corresponding to the second via sub-hole VH22 are etched to expose the first conductive sub-layer.

As shown in FIG. 7E, the photoresist PR on a side of the hard mask HM away from the base substrate is removed.

As shown in FIG. 7F, the hard mask HM on a side of the first planarization layer 61 away from the base substrate is further removed to form the second via sub-hole VH22 in the second via hole.

In some embodiments of the present disclosure, the first planarization layer 61 may be made of, for example, an organic photosensitive material, which has a light transmittance greater than 59%. In the planarization process of the first via sub-hole using the first planarization layer 61, drying and curing are performed on the first planarization layer, where the heating rate of the drying and curing is in a range of 5° C./min to 15° C./min, so that the planarization layer has a good flatness.

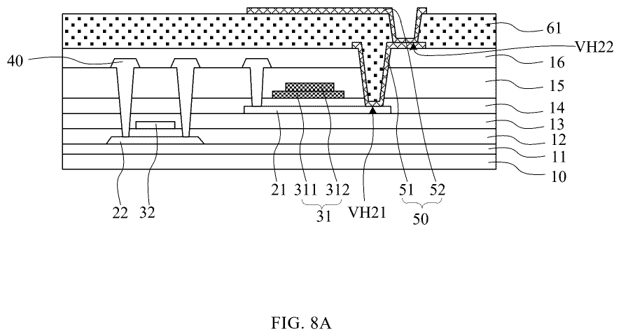

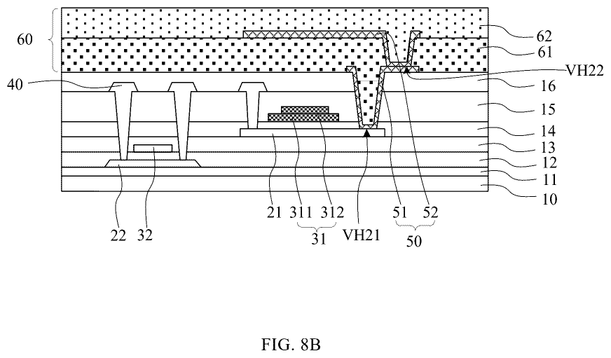

FIG. 8A to FIG. 8B show flowcharts of a planarization process of the second via hole of the liquid crystal display substrate according to an exemplary embodiment of the present disclosure.

As shown in FIG. 8A, after forming the second via sub-hole VH22, the second conductive sub-layer 52 is formed in the second via sub-hole VH22.

As shown in FIG. 8B, the second planarization layer 62 is formed on the second conductive sub-layer 52 so as to perform an effective planarization on the second via sub-hole in the second via hole.

In some embodiments of the present disclosure, the step of performing planarization by the second planarization layer includes drying and curing the second planarization layer, where the heating rate of the drying and curing is in a range of 5° C./min to 15° C./min, so that the planarization layer has a good flatness.

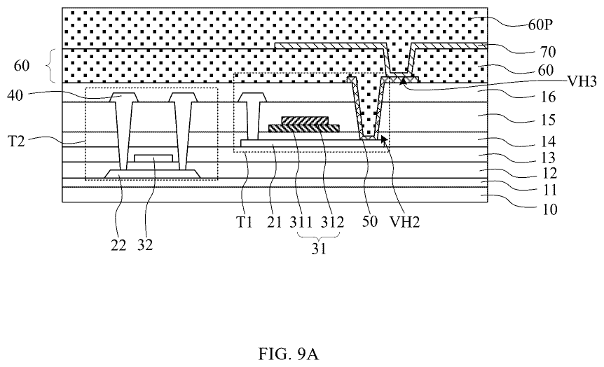

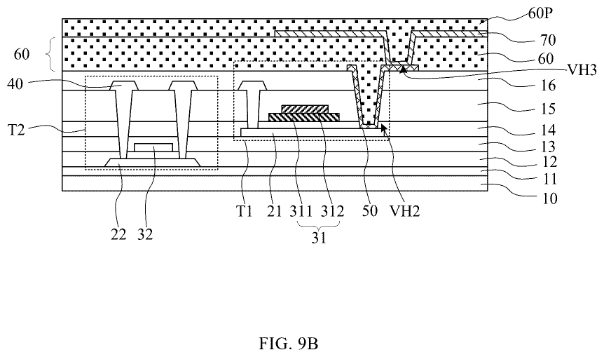

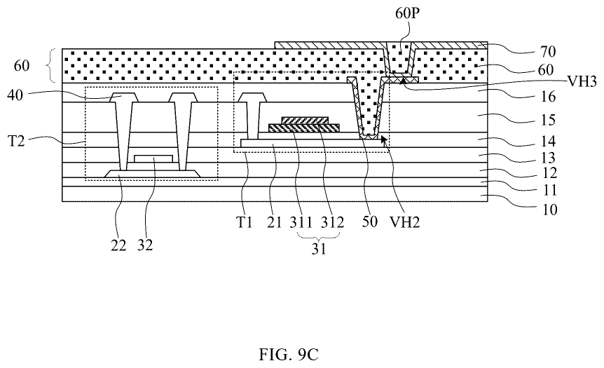

FIG. 9A to FIG. 9C show flowcharts of a planarization process of the third via hole of the liquid crystal display substrate according to an exemplary embodiment of the present disclosure.

the planarization process of the third via hole includes the following steps.

As shown in FIG. 9A, the third conductive layer 70 is formed in the third via hole VH3 on a side of the planarization layer 60 away from the base substrate. A planarization layer 60P is then formed on a side of the third conductive layer 70 away from the base substrate to fill the third via hole VH3. A material of the planarization layer 60P may be, for example, the same as or similar to the material of the planarization layer 60.

As shown in FIG. 9B, the planarization layer 60P is thinned through a lithography thinning process, thereby reducing a residual thickness after planarization, while reducing a time of subsequent processes and increasing a yield.

As shown in FIG. 9C, the planarization layer material outside the region of the third via hole VH3 is removed by further using an ashing process, so that a segment difference between an upper surface corresponding to the region of the third via hole and an upper surface of the third conductive layer 70 meet the requirements for planarization.

In some exemplary embodiments of the present disclosure, the planarization layer material in the region of the third via hole VH3 may be thinned, for example, through a half tone process, and a structure shown in FIG. 6C may be obtained, for example.

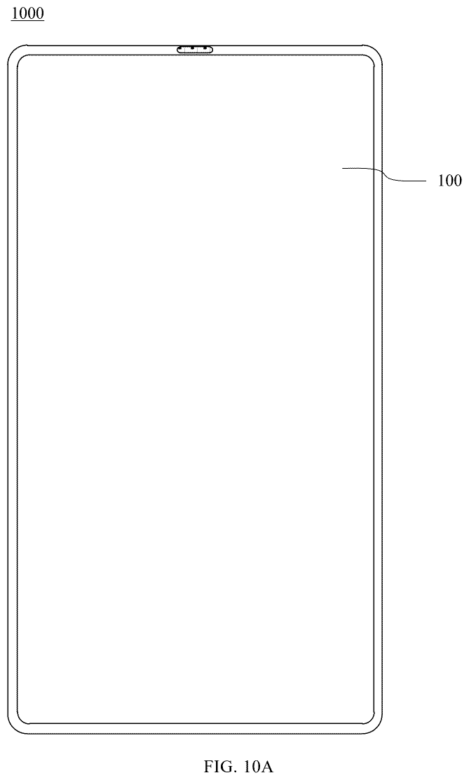

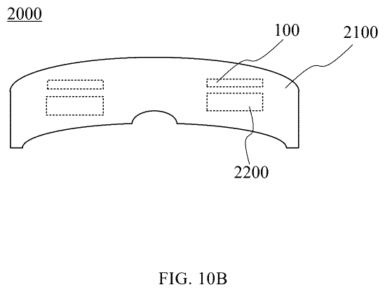

FIG. 10A shows a schematic structural diagram of a display device according to an exemplary embodiment of the present disclosure. FIG. 10B shows a schematic structural diagram of a display device according to another exemplary embodiment of the present disclosure.

In some embodiments of the present disclosure, as shown in FIG. 10A, the embodiments of the present disclosure further provide a display device 1000. The display device 1000 may include the above-mentioned liquid crystal display substrate (100, 100′, 200, 200′, 300, 300′, 400, 400′, 500, 500′) and other liquid crystal display substrates.

In some other embodiments of the present disclosure, as shown in FIG. 10B, a display device 2000 is further provided. The display device 2000 may be a head-mounted display device, such as a VR or MR apparatus. The display device 2000 includes a housing 2100, the liquid crystal display substrate 100 described above, and an optical assembly 2200. The optical assembly 2200 is used to refract an image generated in the liquid crystal display substrate 100 so that information displayed on the liquid crystal display substrate 100 is visible to a user.

Beneficial effects that may be achieved by the display device in the above embodiments of the present disclosure are the same as the beneficial effects that may be achieved by the above-mentioned display substrate, which will not be repeated here.

The above-mentioned display device may be any device that displays a moving image (such as videos) or a fixed image (such as still images) and that displays a text or an image. More specifically, it is expected that the embodiments may be implemented in or associated with various electronic devices. The various electronic devices may include (but not be limited to) a mobile phone, a wireless device, a personal data assistant (PDA), a handheld or portable computer, a GPS receiver/navigator, a camera, a MP4 video player, a video camera, a game console, a watch, a clock, a calculator, a television monitor, a flat panel display, a computer monitor, a vehicle display (such as odometer display), a navigator, a cockpit controller and/or display, a display for camera view (such as display of rear view camera in vehicle), an electronic photo, an electronic billboard or sign, a projector, an architectural structure, a packaging and aesthetic structure (such as display for image of jewelry), etc.

Here, the terms “substantially”, “about”, “approximately”, “roughly” and other similar terms are used as terms of approximation rather than terms of degree, and they are intended to explain an inherent deviation of a measured or calculated value that will be recognized by those ordinary skilled in the art. Taking into account a process fluctuation, a measurement problem, an error related to a measurement of a specific quantity (that is, a limitation of a measurement system) and other factors, the terms “about” or “approximately” used here includes a stated value and means that a specific value determined by those ordinary skilled in the art is within an acceptable range of deviation. For example, “about” may mean being within one or more standard deviations, or within ±30%, ±20%, ±10% or ±5% of the stated value.

Although some embodiments of the general technical concept of the present disclosure have been illustrated and described, it should be understood by those ordinary skilled in the art that these embodiments may be changed without departing from the principle and spirit of the general technical concept of the present disclosure. The scope of the present disclosure is defined by the claims and their equivalents.

1. A liquid crystal display substrate, comprising a plurality of pixel units provided in a display region of the liquid crystal display substrate, the pixel unit comprising a first thin film transistor, wherein the liquid crystal display substrate comprises:
a base substrate;
a first semiconductor layer provided on a side of the base substrate, wherein an active layer of the first thin film transistor is located in the first semiconductor layer;
a first gate layer provided on a side of the first semiconductor layer away from the base substrate, wherein a gate electrode of the first thin film transistor is located in the first gate layer;
a first conductive layer provided on a side of the first gate layer away from the base substrate, wherein the first conductive layer is electrically connected to the active layer of the first thin film transistor through a first via hole so as to form a first electrode of the first thin film transistor;
a second conductive layer provided on a side of the first conductive layer away from the base substrate, wherein the second conductive layer is electrically connected to the active layer of the first thin film transistor through a second via hole so as to form a second electrode of the first thin film transistor;
a planarization layer provided on a side of the second conductive layer away from the base substrate, wherein a part of the planarization layer fills the second via hole;
a third conductive layer provided on a side of the planarization layer away from the base substrate, wherein the third conductive layer is electrically connected to the second conductive layer through a third via hole, and a pixel electrode of the pixel unit is located in the third conductive layer;
a passivation layer provided on a side of the third conductive layer away from the base substrate;
a fourth conductive layer provided on a side of the passivation layer away from the base substrate, wherein a common electrode of the plurality of pixel units is located in the fourth conductive layer;
a liquid crystal layer provided on a side of the fourth conductive layer away from the base substrate, wherein the liquid crystal layer is located in the display region; and
a black matrix layer provided on a side of the liquid crystal layer away from the base substrate, wherein the black matrix layer is located in the display region, and the black matrix layer comprises a black matrix region and a black matrix opening region,
wherein the second conductive layer, the third conductive layer and the fourth conductive layer comprise a transparent conductive material, and an orthographic projection of the second via hole on the base substrate falls within an orthographic projection of the black matrix opening region on the base substrate.

2. The liquid crystal display substrate of claim 1,
wherein the second via hole comprises a first end away from the base substrate and a second end close to the base substrate; and
wherein a via hole opening area of the second via hole parallel to an upper surface of the base substrate gradually decreases from the first end to the second end.

3. The liquid crystal display substrate of claim 2,
wherein a sidewall section line of the second via hole has a first angle θ1 with the upper surface of the base substrate;
wherein 45°<θ1<90°; and
wherein the sidewall section line of the second via hole is obtained by intersecting a sidewall of the second via hole and a section where a symmetry axis of the second via hole is located.

4. The liquid crystal display substrate of claim 3, wherein a slope change rate of the sidewall section line close to the first end is greater than a slope change rate of the sidewall section line close to the second end.

5. The liquid crystal display substrate of claim 4,
wherein the first end of the second via hole has a via hole width a, and the second end of the second via hole has a via hole width b; and
wherein 2.5 μm≤a≤4.5 μm, 1.5 μm≤b≤3.5 μm.

6. The liquid crystal display substrate of claim 5,
wherein the planarization layer comprises a first planarization region and a second planarization region;
wherein an orthographic projection of the first planarization region on the base substrate falls within the orthographic projection of the second via hole on the base substrate, and the second planarization region is a region outside the first planarization region; and
wherein the first planarization region comprises a first planarization surface away from the second conductive layer, the second planarization region comprises a second planarization surface away from the second conductive layer, and a segment difference between the first planarization surface and the second planarization surface is less than 0.2 μm.

7. The liquid crystal display substrate of claim 1, wherein in a direction perpendicular to the upper surface of the base substrate, a depth H₁ of the second via hole and a thickness H₂ of the planarization layer meet a linear relationship of:
$${H}_{1} = A \times {H}_{2} + 0.2 , where 0.4 \leq A \leq 0.6 .$$

8. The liquid crystal display substrate of claim 7, further comprising:
a supporting material layer provided between the passivation layer and the black matrix layer to separate the pixel unit into a plurality of sub-pixels,
wherein an orthographic projection of the supporting material layer on the base substrate falls within an orthographic projection of the black matrix region on the base substrate.

9. The liquid crystal display substrate of claim 8, further comprising:
a light shielding layer provided between the supporting material layer and the passivation layer,
wherein an orthographic projection of the light shielding layer on the base substrate falls within the orthographic projection of the black matrix region on the base substrate.

10. The liquid crystal display substrate of claim 9, wherein an orthographic projection of the third via hole on the base substrate falls within the orthographic projection of the black matrix opening region on the base substrate.

11. The liquid crystal display substrate of claim 9, wherein an orthographic projection of the third via hole on the base substrate falls within the orthographic projection of the black matrix region on the base substrate.

12. The liquid crystal display substrate of claim 10,
wherein the planarization layer comprises a first planarization sub-portion and a second planarization sub-portion;
wherein a part of the second conductive layer and a part of the first planarization sub-portion fill the second via hole; and
wherein a part of the third conductive layer and the second planarization sub-portion fill the third via hole, and an orthographic projection of the second planarization sub-portion on the base substrate falls within the orthographic projection of the third via hole on the base substrate.

13. The liquid crystal display substrate of claim 11,
wherein the planarization layer comprises a first planarization layer close to the second conductive layer and a second planarization layer away from the second conductive layer;
wherein the second via hole penetrates the first planarization layer and exposes the active layer of the first thin film transistor, and a part of the second conductive layer and a part of the planarization layer fill the second via hole;
wherein the third via hole penetrates the second planarization layer and exposes the second conductive layer, and a part of the passivation layer and a part of the supporting material layer fill the third via hole;
wherein the liquid crystal display substrate further comprises: an interlayer insulation layer provided between the first semiconductor layer and the planarization layer;
wherein the second via hole comprises a first via sub-hole and a second via sub-hole;
wherein the second conductive layer comprises a first conductive sub-layer close to the base substrate and a second conductive sub-layer away from the base substrate;
wherein the first via sub-hole penetrates the interlayer insulation layer and exposes the active layer of the first thin film transistor, and a part of the first conductive sub-layer and a part of the first planarization layer fill the first via sub-hole;
wherein the second via sub-hole penetrates the first planarization layer and exposes the first conductive sub-layer, and a part of the second conductive sub-layer and a part of the second planarization layer fill the second via sub-hole;
wherein the supporting material layer comprises a first supporting material layer close to the passivation layer and a second supporting material layer away from the passivation layer, and
wherein the orthographic projection of the third via hole on the base substrate falls within an orthographic projection of the first supporting material layer on the base substrate, and a part of the first supporting material layer fills the third via hole.

14-15. (canceled)

16. The liquid crystal display substrate of claim 13, further comprising:
a color filter layer provided in a same layer as the planarization layer, wherein an orthographic projection of the color filter layer on the base substrate falls within the orthographic projection of the black matrix opening region on the base substrate;
wherein a thickness H3 of the color filter layer, a thickness H21 of the first planarization layer and a thickness H22 of the second planarization layer meet a relationship of:
$$H 21 + H 22 > H 3.$$

17. (canceled)

18. The liquid crystal display substrate of claim 13, further comprising:
a color filter layer provided in a same layer as the black matrix layer, wherein an orthographic projection of the color filter layer on the base substrate falls within the orthographic projection of the black matrix opening region on the base substrate.

19. The liquid crystal display substrate of claim 7,
wherein an orthographic projection of the first thin film transistor on the base substrate overlaps with the orthographic projection of the black matrix opening region on the substrate;
wherein the first gate layer comprises a first gate sub-layer and a second gate sub-layer;
wherein at least one of the first gate sub-layer and the second gate sub-layer comprises a transparent conductive material; and
wherein the third via hole has a same shape as the second via hole, and the planarization layer comprises an organic transparent material.

20. (canceled)

21. The liquid crystal display substrate of claim 1,
wherein the plurality of pixel units comprise a first group of pixel units arranged in a first direction and a second group of pixel units arranged in the first direction, and the first group of pixel units is adjacent to the second group of pixel units in a second direction perpendicular to the first direction;
wherein sub-pixels in the first group of pixel units are staggered with sub-pixels in the second group of pixel units in the second direction; or
the sub-pixels in the first group of pixel units are aligned with the sub-pixels in the second group of pixel units in the second direction.

22. A method of manufacturing a liquid crystal display substrate, the liquid crystal display substrate comprising a plurality of pixel units provided in a display region, the pixel unit comprising a first thin film transistor, the method of manufacturing the liquid crystal display substrate comprising:
providing a base substrate;
forming a first semiconductor layer on a side of the base substrate, wherein an active layer of the first thin film transistor is located in the first semiconductor layer;
forming a first gate layer on a side of the first semiconductor layer away from the base substrate, wherein a gate electrode of the first thin film transistor is located in the first gate layer;
forming a first conductive layer on a side of the first gate layer away from the base substrate, wherein the first conductive layer is electrically connected to the active layer of the first thin film transistor through a first via hole so as to form a first electrode of the first thin film transistor;
forming a second via hole to expose the active layer of the first thin film transistor;
forming a second conductive layer on a side of the first conductive layer away from the base substrate, wherein the second conductive layer is electrically connected to the active layer of the first thin film transistor through a second via hole so as to form a second electrode of the first thin film transistor;
forming a planarization layer on a side of the second conductive layer away from the base substrate, wherein a part of the planarization layer fills the second via hole;
forming a third conductive layer on a side of the planarization layer away from the base substrate, wherein the third conductive layer is electrically connected to the second conductive layer through a third via hole, and a pixel electrode of the pixel unit is located in the third conductive layer;
forming a passivation layer on a side of the third conductive layer away from the base substrate;
forming a fourth conductive layer on a side of the passivation layer away from the base substrate, wherein a common electrode of the plurality of pixel units is located in the fourth conductive layer;
forming a liquid crystal layer on a side of the fourth conductive layer away from the base substrate, wherein the liquid crystal layer is located in the display region; and
forming a black matrix layer on a side of the liquid crystal layer away from the base substrate, wherein the black matrix layer is located in the display region, and the black matrix layer comprises a black matrix region and a black matrix opening region,
wherein the second conductive layer, the third conductive layer and the fourth conductive layer comprise a transparent conductive material, and an orthographic projection of the second via hole on the base substrate falls within an orthographic projection of the black matrix opening region on the base substrate.

23. The method of claim 22, wherein the forming the second via hole to expose the active layer of the first thin film transistor comprises:
etching an insulation layer on a side of the first conductive layer away from the base substrate to form the second via hole so as to expose the active layer of the first thin film transistor;
wherein the second via hole comprises a first end away from the base substrate and a second end close to the base substrate, and a via hole opening area of the second via hole parallel to an upper surface of the base substrate gradually decreases from the first end to the second end;
wherein a sidewall section line of the second via hole has a first angle θ1 with the upper surface of the base substrate;
wherein 45°<θ1<90°;
wherein the sidewall section line of the second via hole is obtained by intersecting a sidewall of the second via hole and a section wherein a symmetry axis of the second via hole is located;
wherein a slope change rate of the sidewall section line close to the first end is greater than a slope change rate of the sidewall section line close to the second end;
wherein the first end of the second via hole has a via width a, and the second end of the second via hole has a via width b;
wherein 2.5 μm≤a≤4.5 μm, 1.5 μm≤b≤3.5 μm; and
wherein the forming the planarization layer on a side of the second conductive layer away from the base substrate comprises:
drying and curing the planarization layer, wherein a heating rate of the drying and curing is in a range of 5° C./min to 15° C./min.

24. (canceled)

25. A display device, comprising the liquid crystal display substrate of claim 1.
